(19) United States
(12) Patent Application Publication
(10) Pub. No.: US 2005/0029498 A1
(43) Pub. Date: Feb. 10, 2005

(54) Electrically conductive compositions and method of manufacture thereof

(76) Inventors: Mark Elkovitch, Delmar, NY (US); Srinivasan Rajagopalan, Bangalore (IN); Soumyadeb Ghosh, Bangalore (IN); Nitin Hiralal Mutha, Maharashtra (IN)

Correspondence Address: Hanh T. Pham;General Electric Company, One Plastics Avenue, Pittsfield, MA, 01201, US

(21) Appl. No.: 10/912,919

(22) Filed: Aug. 6, 2004

Related U.S. Application Data
(60) Provisional application No. 60/493,845, filed on Aug. 8, 2003.
(60) Provisional application No. 60/501,504, filed on Sep. 9, 2003.

(51) Int. Cl. D01F 9/12; H01C 1/00

(52) U.S. Cl. 252/500

(57) ABSTRACT

Disclosed herein is an electrically conductive composition comprising an organic polymer; and a carbon nanotube composition, wherein the carbon nanotube composition comprises carbon nanotubes that can rope and have greater than or equal to about 0.1 wt % production related impurities, based on the total weight of the carbon nanotube composition, and wherein the composition has a bulk volume resistivity less than or equal to about 10¹² ohm-cm, and a notched Izod impact strength of greater than or equal to about 5 kilojoules/square meter.

### CROSS-REFERENCE TO RELATED APPLICATIONS

This application claims priority to U.S. Provisional Application Ser. No. 60/493,845, filed Aug. 8, 2003 and to U.S. Provisional Application Ser. No. 60/501,504, filed Sep. 9, 2003.

### BACKGOUND OF THE INVENTION

This disclosure relates to electrically conductive compositions and methods of manufacture thereof.

Articles made from organic polymers are commonly utilized in material-handling and electronic devices such as packaging film, chip carriers, computers, printers and photocopier components where electrostatic dissipation or electromagnetic shielding are important requirements. Electrostatic dissipation (hereinafter ESD) is defined as the transfer of electrostatic charge between bodies at different potentials by direct contact or by an induced electrostatic field. Electromagnetic shielding (hereinafter EM shielding) effectiveness is defined as the ratio (in decibels) of the proportion of an electromagnetic field incident upon the shield that is transmitted through it. As electronic devices become smaller and faster, their sensitivity to electrostatic charges is increased and hence it is generally desirable to utilize organic polymers that have been modified to provide improved electrostatically dissipative properties. In a similar manner, it is desirable to modify organic polymers so that they can provide improved electromagnetic shielding while simultaneously retaining some or all of the advantageous mechanical properties of the organic polymers.

Conductive fillers such as graphite fibers derived from pitch and polyacrylonitrile having diameters larger than 2 micrometers are often incorporated into organic polymers to improve the electrical properties and achieve ESD and EM shielding. However, because of the large size of these graphite fibers, the incorporation of such fibers generally causes a decrease in the mechanical properties such as impact. There accordingly remains a need in the art for conductive polymeric compositions, which while providing adequate ESD and EM shielding, can retain their mechanical properties.

### BRIEF DESCRIPTION OF THE INVENTION

In one embodiment, an electrically conductive composition comprises an organic polymer; and a carbon nanotube composition, wherein the carbon nanotube composition comprises carbon nanotubes that can rope and have greater than or equal to about 0.1 wt % production related impurities, based on the total weight of the carbon nanotube composition, and wherein the composition has a bulk volume resistivity less than or equal to about 10¹² ohm-cm, and a notched Izod impact strength of greater than or equal to about 5 kilojoules/square meter.

In another embodiment, an electrically conductive composition comprises an organic polymer; and a carbon nanotube composition that comprises carbon nanotubes, wherein the carbon nanotubes of the carbon nanotubes composition have greater than or equal to about 0.1 wt % production related impurities, based on the total weight of the carbon nanotube composition; and wherein the carbon nanotubes are present in the organic polymer in the form of a network that comprises ropes; and wherein the electrically conductive composition has a bulk volume resistivity less than or equal to about 10⁸ ohm-cm, and a notched Izod impact strength of greater than or equal to about 10 kilojoules/square meter.

In yet another embodiment, an electrically conductive composition comprises an organic polymer; and a carbon nanotube composition that comprises carbon nanotubes, wherein the carbon nanotubes of the carbon nanotubes composition have greater than or equal to about 0.1 wt % production related impurities, based on the total weight of the carbon nanotube composition; and wherein the carbon nanotubes are present in the organic polymer in the form of a network that comprises ropes and agglomerates; and wherein the electrically conductive composition has a bulk volume resistivity less than or equal to about 10⁸ ohm-cm, a notched Izod impact strength of greater than or equal to about 10 kilojoules/square meter and a Class A surface finish.

Disclosed herein is a method for manufacturing a composition comprising blending an organic polymer and/or an organic polymer precursor composition with a carbon nanotube composition, wherein the carbon nanotube composition comprises carbon nanotubes that can rope, and wherein the carbon nanotube composition comprises an amount of greater than or equal to about 0.1 wt % production related impurities based on the total weight of the carbon nanotube composition.

Disclosed herein too is a method for manufacturing an electrically conductive composition comprising blending a carbon nanotube composition with an organic polymer or an organic polymer precursor; wherein the carbon nanotube composition contains carbon nanotubes that can rope; and wherein a rope comprising carbon nanotubes has its dimensions altered upon blending.

Disclosed herein too is a method of preparing an electrically conductive composition comprising blending a first organic polymer and a carbon nanotube composition to form a masterbatch; wherein the carbon nanotube composition comprises production related impurities in an amount of greater than or equal to about 0.1 wt %, based upon the total weight of the carbon nanotube composition; and wherein the carbon nanotube composition comprises carbon nanotubes that can rope; and further blending the masterbatch with a second organic polymer to form the electrically conductive composition.

### BRIEF DESCRIPTION OF THE DRAWINGS

FIG. 1 is a schematic diagram depicting the structure of a graphitic nanosheets;

FIG. 2 is a graphical representation of specific volume resistivity for a nylon 6,6 sample having SWNT-3 and SWNT-10; and

FIG. 3 is an electron micrograph showing the dispersion of SWNTs in compositions, wherein the SWNTs are SWNT-3 and SWNT-10 respectively.

### DETAILED DESCRIPTION OF THE INVENTION

It is to be noted that as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges disclosed herein are inclusive of the endpoints and are independently combinable.

Disclosed herein are electrically conductive compositions comprising one or more organic polymers and a carbon nanotube composition that has a bulk volume resistivity less than or equal to about 10¹² ohm-cm, while displaying impact properties greater than or equal to about 5 kilojoules/square meter and a Class A surface finish. The carbon nanotube composition comprises carbon nanotubes that can undergo roping and have production related impurities in an amount of greater than or equal to about 1, greater than or equal to about 2, and greater than or equal to about 5 weight percent (wt %), based on the total weight of the carbon nanotubes. In an advantageous feature, the presence of such production related impurities facilitates the dispersion of the carbon nanotubes within the matrix of the organic polymer and/or promote the use of reduced amounts of energy in the formation of electrically conductive networks through the matrix of the organic polymer. The presence of ropes permits the formation of electrically conductive networks through the electrically conductive composition using a smaller volume fraction of carbon nanotubes. The ropes are advantageously present in single wall carbon nanotubes, multiwall carbon nanotubes and combinations of single wall carbon nanotubes with multiwall carbon nanotubes. In one embodiment, the electrically conductive composition is manufactured from a masterbatch that contains carbon nanotubes that can rope.

In one embodiment, the electrically conductive composition has a surface resistivity greater than or equal to about 10¹² ohm/square (ohm/sq) while having a bulk volume resistivity less than or equal to about 10⁸ ohm-cm, while displaying impact properties greater than or equal to about 5 kilojoules/square meter and a Class A surface finish. In another embodiment, the electrically conductive composition has a bulk resistivity of less than or equal to about 10⁸ ohm-cm, while displaying impact properties greater than or equal to about 10 kilojoules/square meter. In yet another embodiment, the electrically conductive composition has a bulk resistivity of less than or equal to about 10⁸ ohm-cm, while displaying impact properties greater than or equal to about 15 kilojoules/square meter. In yet another embodiment, the composition has a bulk resistivity of less than or equal to about 10⁸ ohm-cm, while displaying impact properties greater than or equal to about 20 kilojoules/square meter. The electrically conductive composition can be molded into articles have a Class A surface finish.

Such electrically conductive compositions can be advantageously utilized in computers, electronic goods, semi-conductor components, circuit boards, or the like which need to be protected from electrostatic charges. They may also be used advantageously in automotive body panels both for interior and exterior components of automobiles that can be electrostatically painted if desired.

It has been inadvertently discovered that a conducting filler comprising a variety of particle sizes and shapes produce an electrically conductive composition with a low percolation threshold. Carbon nanotubes, due to their tubular (high aspect ratio) geometry and strong van der Waal's interaction, agglomerate as ropes. During processing, it is desirable for these ropes to disperse and to randomly branch-out to join with other ropes thereby forming an electrically conductive network. However, this branching is not easily accomplished because the van der Waal's forces are not easily overcome. It has been hereby discovered that carbon nanotubes having a variety of different particle sizes and shapes in the form of production related impurities, can be easily dispersed to form percolating networks. It has also been advantageously discovered that a carbon nanotube composition that comprises particles having a variety of sizes and shapes can be more easily dispersed in a organic polymer than a carbon nanotube composition that has more homogeneous particle sizes.

The organic polymer used in the electrically conductive compositions may be selected from a wide variety of thermoplastic resins, blend of thermoplastic resins, or blends of thermoplastic resins with thermosetting resins. The organic polymer may also be a blend of polymers, copolymers, terpolymers, or combinations comprising at least one of the foregoing organic polymers. Specific, but non-limiting examples of thermoplastic resins include polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, and combinations comprising at least one of the foregoing organic polymers.

Specific non-limiting examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations comprising at least one of the foregoing blends of thermoplastic resins.

In one embodiment, an organic polymer that may be used in the electrically conductive composition is a polyarylene ether. The term poly(arylene ether) polymer includes polyphenylene ether (PPE) and poly(arylene ether) copolymers; graft copolymers; poly(arylene ether) ether ionomers; and block copolymers of alkenyl aromatic compounds with poly(arylene ether)s, vinyl aromatic compounds, and poly(arylene ether), and the like; and combinations comprising at least one of the foregoing. Poly(arylene ether) polymers per se, are polymers comprising a plurality of structural units of the formula (I): 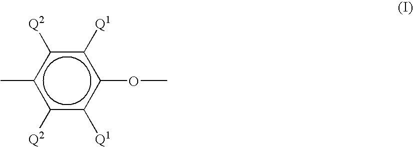
wherein for each structural unit, each Q¹ is independently hydrogen, halogen, primary or secondary lower alkyl (e.g., alkyl containing up to 7 carbon atoms), phenyl, haloalkyl, aminoalkyl, hydrocarbonoxy, halohydrocarbonoxy wherein at least two carbon atoms separate the halogen and oxygen atoms, or the like; and each Q² is independently hydrogen, halogen, primary or secondary lower alkyl, phenyl, haloalkyl, hydrocarbonoxy, halohydrocarbonoxy wherein at least two carbon atoms separate the halogen and oxygen atoms, or the like. Each Q¹ can be alkyl or phenyl, especially C₁₋₄ alkyl, and each Q² can be hydrogen.

Both homopolymer and copolymer poly(arylene ether)s are included. Exemplary homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles and formals undergo reaction with the hydroxy groups of two poly(arylene ether) chains to produce a higher molecular weight polymer. Poly(arylene ether)s further include combinations comprising at least one of the above.

The poly(arylene ether) has a number average molecular weight of about 10,000 to about 30,000 grams/mole (g/mole) and a weight average molecular weight of about 30,000 to about 60,000 g/mole, as determined by gel permeation chromatography. The poly(arylene ether) may have an intrinsic viscosity of about 0.10 to about 0.60 deciliters per gram (dl/g), as measured in chloroform at 25° C. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

The poly(arylene ether) is typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

Particularly useful poly(arylene ether)s for many purposes are those, which comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90% by weight of the polymer, may contain at least one of the aminoalkyl-containing and 4-hydroxybiphenyl end groups.

In another embodiment, the organic polymer used in the electrically conductive composition may be a polycarbonate. Polycarbonates comprising aromatic carbonate chain units include compositions having structural units of the formula (II): 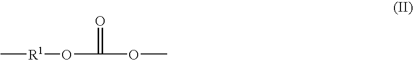
in which the R¹ groups are aromatic, aliphatic or alicyclic radicals. R¹ is an aromatic organic radical and, more desirably, a radical of the formula (III): 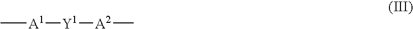
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative examples of radicals of this type are —O—, —S—, —S(O)—, —S(02)—, —C(O)—, methylene, cyclohexyl-methylene, 2-[2,2,1 ]-bicycloheptylidene, ethylidene, isopropylidene, neopentylidene, cyclohexylidene, cyclopentadecylidene, cyclododecylidene, adamantylidene, or the like. The bridging radical Y¹ can be a hydrocarbon group or a saturated hydrocarbon group such as methylene, cyclohexylidene or isopropylidene.

Polycarbonates may be produced by the Schotten-Bauman interfacial reaction of the carbonate precursor with dihydroxy compounds. Typically, an aqueous base such as sodium hydroxide, potassium hydroxide, calcium hydroxide, or the like, is mixed with an organic, water immiscible solvent such as benzene, toluene, carbon disulfide, or dichloromethane, which contains the dihydroxy compound. A phase transfer agent is generally used to facilitate the reaction. Molecular weight regulators may be added either singly or in admixture to the reactant mixture. Branching agents, described forthwith may also be added singly or in admixture.

Aromatic dihydroxy compound comonomers that can be employed in the disclosure comprise those of the general formula (IV): 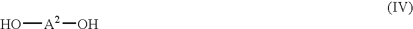
wherein A² is selected from divalent substituted and unsubstituted aromatic radical.

In some embodiments, A² has the structure of formula (V): 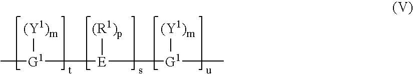
wherein G¹ represents an aromatic group, such as phenylene, biphenylene, naphthylene, or the like. E may be an alkylene or alkylidene group such as methylene, ethylene, ethylidene, propylene, propylidene, isopropylidene, butylene, butylidene, isobutylidene, amylene, amylidene, isoamylidene, or the like and may consist of two or more alkylene or alkylidene groups connected by a moiety different from alkylene or alkylidene, such as an aromatic linkage; a tertiary amino linkage; an ether linkage; a carbonyl linkage; a silicon-containing linkage; or a sulfur-containing linkage such as sulfide, sulfoxide, sulfone, or the like; or a phosphorus-containing linkage such as phosphinyl, phosphonyl, or the like. In addition, E may be a cycloaliphatic group. R¹ represents hydrogen or a monovalent hydrocarbon group such as alkyl, aryl, aralkyl, alkaryl, or cycloalkyl. Y¹ may be an inorganic atom such as halogen (fluorine, bromine, chlorine, iodine); an inorganic group such as nitro; an organic group such as alkenyl, allyl, or R¹ above, or an oxy group such as OR; it being only necessary that Y¹ be inert to and unaffected by the reactants and reaction conditions used to prepare the polymer. The letter m represents any integer from and including zero through the number of positions on G¹ available for substitution; p represents an integer from and including zero through the number of positions on E available for substitution; “t” represents an integer equal to at least one; “s” is either zero or one; and “u” represents any integer including zero.

Suitable examples of E include cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, or the like; a sulfur-containing linkage, such as sulfide, sulfoxide or sulfone; a phosphorus-containing linkage, such as phosphinyl, phosphonyl; an ether linkage; a carbonyl group; a tertiary nitrogen group; or a silicon-containing linkage such as silane or siloxy. In the aromatic dihydroxy comonomer compound (III) in which A² is represented by formula (IV) above, when more than one Y¹ substituent is present, they may be the same or different. The same holds true for the R¹ substituent. Where s is zero in formula (IV) and u is not zero, the aromatic rings are directly joined with no intervening alkylidene or other bridge. The positions of the hydroxyl groups and Y¹ on the aromatic nuclear residues G¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments, the parameters “t”, “s”, and “u” are each one; both G¹ radicals are unsubstituted phenylene radicals; and E is an alkylidene group such as isopropylidene. In particular embodiments, both G¹ radicals are p-phenylene, although both may be o- or m-phenylene or one o- or m-phenylene and the other p-phenylene. Suitable examples of aromatic dihydroxy compounds of formula (IV) are illustrated by 2,2-bis(4-hydroxyphenyl)propane (bisphenol A); 2,2-bis(3-chloro-4-hydroxyphenyl)propane; 2,2-bis(3-bromo-4-hydroxyphenyl)propane; 2,2-bis(4-hydroxy-3-methylphenyl)propane; 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 2,2-bis(3,5-dichloro-4-hydroxyphenyl)propane; 2,2-bis(3,5-dibromo-4-hydroxyphenyl)propane; 2,2-bis(3,5-dimethyl-4-hydroxyphenyl)propane; 2,2-bis(3-chloro-4-hydroxy-5-methylphenyl)propane; 2,2-bis(3-bromo-4-hydroxy-5-methylphenyl)propane; 2,2-bis(3-chloro-4-hydroxy-5-isopropylphenyl)propane; 2,2-bis(3-bromo-4-hydroxy-5-isopropylphenyl)propane; 2,2-bis(3-t-butyl-5-chloro-4-hydroxyphenyl)propane; 2,2-bis(3-bromo-5-t-butyl-4-hydroxyphenyl)propane; 2,2-bis(3-chloro-5-phenyl-4-hydroxyphenyl)propane; 2,2-bis(3-bromo-5-phenyl-4-hydroxyphenyl)propane; 2,2-bis(3,5-disopropyl-4-hydroxyphenyl)propane; 2,2-bis(3,5-di-t-butyl-4-hydroxyphenyl)propane; 2,2-bis(3,5-diphenyl4-hydroxyphenyl)propane; 2,2-bis(4-hydroxy-2,3,5,6-tetrachlorophenyl)propane; 2,2-bis(4-hydroxy-2,3,5,6-tetrabromophenyl)propane; 2,2-bis(4-hydroxy-2,3,5,6-tetramethylphenyl)propane; 2,2-bis(2,6-dichloro-3,5-dimethyl4-hydroxyphenyl)propane; 2,2-bis(2,6-dibromo-3,5-dimethyl4-hydroxyphenyl)propane; 1,1-bis(4-hydroxyphenyl)cyclohexane; 1,1-bis(3-chloro4-hydroxyphenyl)cyclohexane; 1,1-bis(3-bromo-4-hydroxyphenyl)cyclohexane; 1,1-bis(4-hydroxy-3-methylphenyl)cyclohexane; 1,1-bis(4-hydroxy-3-isopropylphenyl)cyclohexane; 1,1-bis(3-t-butyl-4-hydroxyphenyl)cyclohexane; 1,1-bis(3-phenyl4-hydroxyphenyl)cyclohexane; 1,1-bis(3,5-dichloro-4-hydroxyphenyl)cyclohexane; 1,1-bis(3,5-dibromo-4-hydroxyphenyl)cyclohexane; 1,1-bis(3,5-dimethyl-4-hydroxyphenyl)cyclohexane; 1,1-bis(3-chloro-4-hydroxy-5-methylphenyl)cyclohexane; 1,1-bis(3-bromo-4-hydroxy-5-methylphenyl)cyclohexane; 1,1-bis(3-chloro-4-hydroxy-5-isopropylphenyl)cyclohexane; 1,1-bis(3-bromo-4-hydroxy-5-isopropylphenyl)cyclohexane; 1,1-bis(3-t-butyl-5-chloro4-hydroxyphenyl)cyclohexane; 1,1-bis(3-bromo-5-t-butyl-4-hydroxyphenyl)cyclohexane; 1,1-bis(3-chloro-5-phenyl-4-hydroxyphenyl)cyclohexane; 1,1-bis(3-bromo-5-phenyl-4-hydroxyphenyl)cyclohexane; 1,1-bis(3,5-disopropyl-4-hydroxyphenyl)cyclohexane; 1,1-bis(3,5-di-t-butyl-4-hydroxyphenyl)cyclohexane; 1,1-bis(3,5-diphenyl-4-hydroxyphenyl)cyclohexane; 1,1-bis(4-hydroxy-2,3,5,6-tetrachlorophenyl)cyclohexane; 1,1-bis(4-hydroxy-2,3,5,6-tetrabromophenyl)cyclohexane; 1,1-bis(4-hydroxy-2,3,5,6-tetramethylphenyl)cyclohexane; 1,1-bis(2,6-dichloro-3,5-dimethyl-4-hydroxyphenyl)cyclohexane; 1,1-bis(2,6-dibromo-3,5-dimethyl4-hydroxyphenyl)cyclohexane; 1,1-bis(4-hydroxyphenyl)-3,3,5-trimethylcyclohexane; 1,1-bis(3-chloro-4-hydroxyphenyl)-3,3,5-trimethylcyclohexane; 1,1-bis(3-bromo-4-hydroxyphenyl)-3,3,5-trimethylcyclohexane; 1,1-bis(4-hydroxy-3-methylphenyl)-3,3,5-trimethylcyclohexane; 1,1-bis(4-hydroxy-3-isopropylphenyl)-3,3,5-trimethylcyclohexane; 1,1-bis(3-t-butyl-4-hydroxyphenyl)-3,3,5-trimethylcyclohexane; 1,1-bis(3-phenyl-4-hydroxyphenyl)-3,3,5-trimethylcyclohexane; 1,1-bis(3,5-dichloro-4-hydroxyphenyl)-3,3,5-trimethylcyclohexane; 1,1-bis(3,5-dibromo-4-hydroxyphenyl)-3,3,5-trimethylcyclohexane; 1,1-bis(3,5-dimethyl-4-hydroxyphenyl)-3,3,5-trimethylcyclohexane; 1,1-bis(3-chloro-4-hydroxy-5-methylphenyl)-3,3,5-trimethylcyclohexane; 1,1-bis(3-bromo-4-hydroxy-5-methylphenyl)-3,3,5-trimethylcyclohexane; 1,1-bis(3-chloro-4-hydroxy-5-isopropylphenyl)-3,3,5-trimethylcyclohexane; 1,1-bis(3-bromo-4-hydroxy-5-isopropylphenyl)-3,3,5-trimethylcyclohexane; 1,1-bis(3-t-butyl-5-chloro-4-hydroxyphenyl)-3,3,5-trimethylcyclohexane; 1,1-bis(3-bromo-5-t-butyl-4-hydroxyphenyl)-3,3,5-trimethylcyclohexane; bis(3-chloro-5-phenyl-4-hydroxyphenyl)-3,3,5-trimethylcyclohexane; 1,1-bis(3-bromo-5-phenyl-4-hydroxyphenyl)-3,3,5-trimethylcyclohexane; 1,1-bis(3,5-disopropyl-4-hydroxyphenyl)-3,3,5-trimethylcyclohexane; 1,1-bis(3,5-di-t-butyl-4-hydroxyphenyl)-3,3,5-trimethylcyclohexane; 1,1-bis(3,5-diphenyl-4-hydroxyphenyl)-3,3,5-trimethylcyclohexane; 1,1-bis(4-hydroxy-2,3,5,6-tetrachlorophenyl)-3,3,5-trimethylcyclohexane; 1,1-bis(4-hydroxy-2,3,5,6-tetrabromophenyl)-3,3,5-trimethylcyclohexane; 1,1-bis(4-hydroxy-2,3,5,6-tetramethylphenyl)-3,3,5-trimethylcyclohexane; 1,1-bis(2,6-dichloro-3,5-dimethyl-4-hydroxyphenyl)-3,3,5-trimethylcyclohexane; 1,1-bis(2,6-dibromo-3,5-dimethyl-4-hydroxyphenyl)-3,3,5-trimethylcyclohexane; 4,4′dihydroxy-1,1-biphenyl; 4,4′-dihydroxy-3,3′-dimethyl-1,1-biphenyl; 4,4′-dihydroxy-3,3′-dioctyl- 1,1-biphenyl; 4,4′-dihydroxydiphenylether; 4,4′-dihydroxydiphenylthioether; 1,3-bis(2-(4-hydroxyphenyl)-2-propyl)benzene; 1,3-bis(2-(4-hydroxy-3-methylphenyl)-2-propyl)benzene; 1,4-bis(2-(4-hydroxyphenyl)-2-propyl)benzene and 1,4-bis(2-(4-hydroxy-3-methylphenyl)-2-propyl)benzene. Exemplary aromatic dihydroxy compound is Bisphenol A (BPA).

Other bisphenol compounds that may be represented by formula (IV) include those where X is —O—, —S—, —SO— or —SO₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides such as 4,4′-dihydroxy diphenyl sulfide, 4,4′-dihydroxy-3,3′-dimethyl diphenyl sulfide, or the like; bis(hydroxy diaryl) sulfoxides such as, 4,4′-dihydroxy diphenyl sulfoxides, 4,4′-dihydroxy-3,3′-dimethyl diphenyl sulfoxides, or the like; bis(hydroxy diaryl)sulfones such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be utilized in the polycondensation of polycarbonate are represented by the formula (VI) 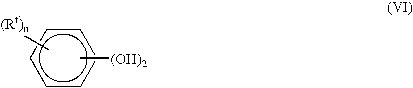
wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (V), are resorcinol, substituted resorcinol compounds such as 3-methyl resorcin, 3-ethyl resorcin, 3-propyl resorcin, 3-butyl resorcin, 3-t-butyl resorcin, 3-phenyl resorcin, 3-cumyl resorcin, 2,3,4,6-tetrafloro resorcin, 2,3,4,6-tetrabromo resorcin, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, 2,3,5,6-tetramethyl hydroquinone, 2,3,5,6-tetra-t-butyl hydroquinone, 2,3,5,6-tetrafloro hydroquinone, 2,3,5,6-tetrabromo hydroquinone, or the like, or combinations comprising at least one of the foregoing bisphenol compounds.

Bisphenol compounds such as 2,2, 2′, 2′-tetrahydro-3, 3, 31, 3′-tetramethyl-1,1′-spirobi-[IH-indene]-6, 6′-diol represented by the following formula (VII) may also be used.

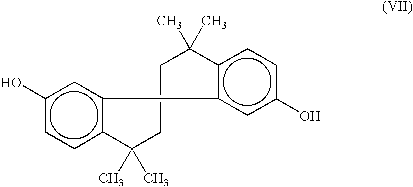

An exemplary bisphenol compound is bisphenol A.

Typical carbonate precursors include the carbonyl halides, for example carbonyl chloride (phosgene) and carbonyl bromide; the bis-haloformates, for example, the bis-haloformates of dihydric phenols such as bisphenol A, hydroquinone, or the like, and the bis-haloformates of glycols such as ethylene glycol and neopentyl glycol; and the diaryl carbonates such as diphenyl carbonate, di(tolyl) carbonate, and di(naphthyl) carbonate. An exemplary carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with. an aliphatic diacid in the event a carbonate copolymer rather than a homopolymer is desired for use. Generally, useful aliphatic diacids have about 2 to about 40 carbons. An exemplary aliphatic diacid is dodecanedioic acid.

Branched polycarbonates, as well as blends of linear polycarbonate and a branched polycarbonate may also be used in the electrically conductive composition. The branched polycarbonates may be prepared by adding a branching agent during polymerization. These branching agents may comprise polyfunctional organic compounds containing at least three functional groups, which may be hydroxyl, carboxyl, carboxylic anhydride, haloformyl, and combinations comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 2.0 weight percent (wt %), based upon the total weight of the polycarbonate.

In one embodiment, the polycarbonate may be produced by a melt polycondensation reaction between a dihydroxy compound and a carbonic acid diester. Examples of the carbonic acid diesters that may be utilized to produce the polycarbonates are diphenyl carbonate, bis(2,4-dichlorophenyl)carbonate, bis(2,4,6-trichlorophenyl) carbonate, bis(2-cyanophenyl) carbonate, bis(o-nitrophenyl) carbonate, ditolyl carbonate, m-cresyl carbonate, dinaphthyl carbonate, bis(diphenyl) carbonate, bis (methylsalicyl)carbonate, diethyl carbonate, dimethyl carbonate, dibutyl carbonate, dicyclohexyl carbonate, or the like, or combinations comprising at least one of the foregoing carbonic acid diesters. An exemplary carbonic acid diester is diphenyl carbonate or bis (methylsalicyl)carbonate).

The number average molecular weight of the polycarbonate is about 3,000 to about 1,000,000 grams/mole (g/mole). In one embodiment, it is desirable to use polycarbonate having a number average molecular weight of about 10,000 to about 100,000 g/mole. In another embodiment, it is desirable to use polycarbonate having a number average molecular weight of about 20,000 to about 75,000 g/mole. In yet another embodiment, it is desirable to use polycarbonate having a number average molecular weight of about 25,000 to about 50,000 g/mole.

Cycloaliphatic polyesters are generally prepared by reaction of a diol with a dibasic acid or derivative. The diols useful in the preparation of the cycloaliphatic polyester polymers are straight chain, branched, or cycloaliphatic, alkane diols, and may contain from 2 to 12 carbon atoms.

Suitable examples of diols include ethylene glycol, propylene glycol, i.e., 1,2- and 1,3-propylene glycol; butane diol, i.e., 1,3- and 1,4-butane diol; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and mixtures of any of the foregoing. Particularly desirable is dimethanol bicyclo octane, dimethanol decalin, a cycloaliphatic diol or chemical equivalents thereof and particularly 1,4-cyclohexane dimethanol or its chemical equivalents. If 1,4-cyclohexane dimethanol is to be used as the diol component, it is generally desirable to use a mixture of cis- to trans-isomers in mole ratios of about 1:4 to about 4:1. Within this range, it is generally desirable to use a mole ratio of cis- to trans- isomers of about 1:3.

The diacids useful in the preparation of the cycloaliphatic polyester polymers are aliphatic diacids that include carboxylic acids having two carboxyl groups each of which are attached to a saturated carbon in a saturated ring. Suitable examples of cycloaliphatic acids include decahydro naphthalene dicarboxylic acid, norbornene dicarboxylic acids, bicyclo octane dicarboxylic acids. Exemplary cycloaliphatic diacids are 1,4-cyclohexanedicarboxylic acid and trans- 1,4-cyclohexanedicarboxylic acids. Linear aliphatic diacids are also useful when the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

Cyclohexanedicarboxylic acids and their chemical equivalents can be prepared, for example, by the hydrogenation of cycloaromatic diacids and corresponding derivatives such as isophthalic acid, terephthalic acid or naphthalenic acid in a suitable solvent, water or acetic acid at room temperature and at atmospheric pressure using suitable catalysts such as rhodium supported on a suitable carrier of carbon or alumina. They may also be prepared by the use of an inert liquid medium wherein an acid is at least partially soluble under reaction conditions and a catalyst of palladium or ruthenium in carbon or silica is used.

Typically, during hydrogenation, two or more isomers are obtained wherein the carboxylic acid groups are in either the cis- or trans-positions. The cis- and trans-isomers can be separated by crystallization with or without a solvent, for example, n-heptane, or by distillation. While the cis-isomer tends to blend better, the trans-isomer has higher melting and crystallization temperature and is generally more desirable. Mixtures of the cis- and trans-isomers may also be used, and when such a mixture is used, the trans-isomer can comprise at least about 75 wt % and the cis-isomer can comprise the remainder based on the total weight of cis- and trans-isomers combined. When a mixture of isomers of more than one diacid is used, a copolyester or a mixture of two polyesters may be used as the cycloaliphatic polyester resin.

Chemical equivalents of these diacids including esters may also be used in the preparation of the cycloaliphatic polyesters. Suitable examples of the chemical equivalents of the diacids are alkyl esters, e.g., dialkyl esters, diaryl esters, anhydrides, acid chlorides, acid bromides, or the like, or combinations comprising at least one of the foregoing chemical equivalents. Exemplary chemical equivalents comprise the dialkyl esters of the cycloaliphatic diacids. A suitable chemical equivalent comprises the dimethyl ester of the acid, particularly dimethyl-trans-1,4-cyclohexanedicarboxylate.

Dimethyl-1,4-cyclohexanedicarboxylate can be obtained by ring hydrogenation of dimethylterephthalate, wherein two isomers having the carboxylic acid groups in the cis- and trans-positions are obtained. The isomers can be separated, the trans-isomer being especially desirable. Mixtures of the isomers may also be used as detailed above.

The polyester polymers are generally obtained through the condensation or ester interchange polymerization of the diol or diol chemical equivalent component with the diacid or diacid chemical equivalent component and having recurring units of the formula (VIII): 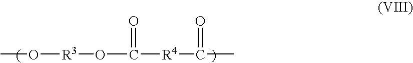
wherein R³ represents an aryl, alkyl or cycloalkyl radical which is the residue of a straight chain, branched, or cycloaliphatic alkane diol or chemical equivalents thereof; and R⁴ is an aryl, alkyl or a cycloaliphatic radical which is the decarboxylated residue derived from a diacid, with the proviso that at least one of R³ or R⁴ is a cycloalkyl group. The aryl radicals may be substituted aryl radicals if desired.

An exemplary cycloaliphatic polyester is poly(1,4-cyclohexane-dimethanol-1,4-cyclohexanedicarboxylate) having recurring units of formula (IX) 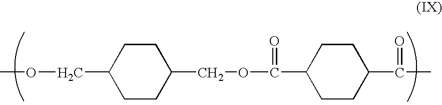
wherein in the formula (VIII), R³ is a cyclohexane ring, and wherein R⁴ is a cyclohexane ring derived from cyclohexanedicarboxylate or a chemical equivalent thereof and is selected from the cis- or trans-isomer or a mixture of cis- and trans-isomers thereof. Cycloaliphatic polyester polymers can be generally made in the presence of a suitable catalyst such as a tetra(2-ethyl hexyl)titanate, in a suitable amount, typically about 50 to 400 ppm of titanium based upon the total weight of the final product. Poly(1,4-cyclohexanedimethanol-1,4-cyclohexanedicarboxylate) generally forms a suitable blend with the polycarbonate.

The number average molecular weight of the copolyestercarbonates or the polyesters is about 3,000 to about 1,000,000 g/mole. In one embodiment, it is desirable to use polyesters having a number average molecular weight of about 10,000 to about 100,000 g/mole. In another embodiment, it is desirable to use polyesters having a number average molecular weight of about 20,000 to about 75,000 g/mole. In yet another embodiment, it is desirable to use polyesters having a number average molecular weight of about 25,000 to about 50,000 g/mole.

Another exemplary polyester is a polyarylate. Polyarylates generally refers to polyesters of aromatic dicarboxylic acids and bisphenols. Polyarylate copolymers that include carbonate linkages in addition to the aryl ester linkages, are termed polyester-carbonates, and may also be advantageously utilized in the mixtures. The polyarylates can be prepared in solution or by the melt polymerization of aromatic dicarboxylic acids or their ester forming derivatives with bisphenols or their derivatives.

In general, it is desirable for the polyarylates to comprise at least one diphenol residue in combination with at least one aromatic dicarboxylic acid residue. An exemplary diphenol residue, illustrated in formula (X), is derived from a 1,3-dihydroxybenzene moiety, referred to throughout this specification as resorcinol or resorcinol moiety. Resorcinol or resorcinol moieties include both unsubstituted 1,3-dihydroxybenzene and substituted 1,3-dihydroxybenzenes.

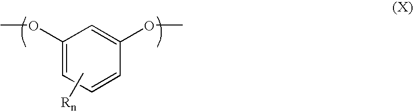

In formula (X), R is at least one of C₁₋₁₂ alkyl or halogen, and n is 0 to 3. Suitable dicarboxylic acid residues include aromatic dicarboxylic acid residues derived from monocyclic moieties, such as isophthalic acid, terephthalic acid, or mixtures of isophthalic and terephthalic acids. Suitable dicarboxylic acids are also derived from polycyclic moieties such as diphenyl dicarboxylic acid, diphenylether dicarboxylic acid, and naphthalene-2,6-dicarboxylic acid, and the like, as well as combinations comprising at least one of the foregoing polycyclic moieties. An exemplary polycyclic moiety is naphthalene-2,6-dicarboxylic acid.

The aromatic dicarboxylic acid residues are derived from mixtures of isophthalic and/or terephthalic acids as generally illustrated in formula (XI).

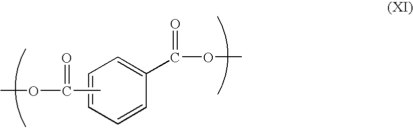

Therefore, in one embodiment the polyarylates comprise resorcinol arylate polyesters as illustrated in formula (XII) 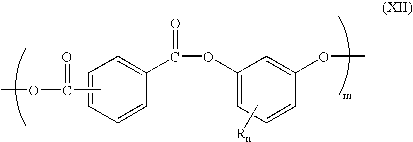
wherein R is at least one of C₁₋₂ alkyl or halogen, n is 0 to 3, and m is at least about 8. It is desirable for R to be hydrogen. In one embodiment, n is zero and m is about 10 and about 300. The molar ratio of isophthalate to terephthalate is about 0.25:1 to about 4.0:1.

In another embodiment, the polyarylate comprises thermally stable resorcinol arylate polyesters that have polycyclic aromatic radicals as shown in formula (XIII) 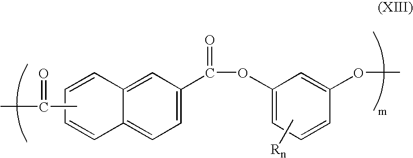
wherein R is at least one of C₁₋₂ alkyl or halogen, n is 0 to 3, and m is at least about 8.

In another embodiment, the polyarylates are copolymerized to form block copolyestercarbonates, which comprise carbonate and arylate blocks. They include polymers comprising structural units of the formula (XIV) 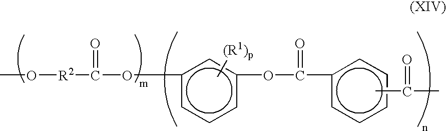
wherein each R¹ is independently halogen or C₁₂ alkyl, m is at least 1, p is about 0 to about 3, each R² is independently a divalent organic radical, and n is at least about 4. In one embodiment, n is at least about 10, more desirably at least about 20 and most desirably about 30 to about 150. It is generally desirable for m to be at least about 3. In one embodiment, m can be at least about 10 while in another embodiment, m can be at least about 20 to about 200. In an exemplary embodiment, m can be about 20 to about 50.

It is generally desirable for the weight average molecular weight of the polyarylate to be about 500 to about 1,000,000 grams/mole (g/mole). In one embodiment, the polyarylate has a weight average molecular weight of about 10,000 to about 200,000 g/mole. In another embodiment, the polyarylate has a weight average molecular weight of about 30,000 to about 150,000 g/mole. In yet another embodiment, the polyarylate has a weight average molecular weight of about 50,000 to about 120,000 g/mole. An exemplary molecular weight for the polyarylate is 60,000 and 120,000 g/mole.

In one embodiment, the polymer precursor comprises an ethylenically unsaturated group. The ethylenically unsaturated groups used can be any ethylenically unsaturated functional group capable of polymerization. Suitable ethylenically unsaturated functionality includes functionalization that can be polymerized through radical polymerization or cationic polymerization. Specific examples of suitable ethylenic unsaturation are groups containing acrylate, methacrylate, vinyl aromatic polymers such as styrene; vinylether, vinyl ester, N-substituted acrylamide, N-vinyl amide, maleate esters, fumarate esters, and the like. The ethylenic unsaturation is provided by a group containing acrylate, methacrylate, or a styrene functionality.

The vinyl aromatic resins are derived from polymer precursors that contain at least 25% by weight of structural units derived from a monomer of the formula (XV): 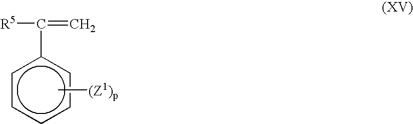
wherein R⁵ is hydrogen, lower alkyl or halogen; Z¹ is vinyl, halogen or lower alkyl; and p is from 0 to about 5. These polymers include homopolymers of styrene, chlorostyrene and vinyltoluene, random copolymers of styrene with one or more monomers illustrated by acrylonitrile, butadiene, alpha -methylstyrene, ethylvinylbenzene, divinylbenzene and maleic anhydride, and rubber-modified polystyrenes comprising blends and grafts, wherein the rubber is a polybutadiene or a rubbery copolymer of about 98-70% styrene and about 2-30% diene monomer. Polystyrenes are miscible with polyphenylene ether in all proportions, and any such blend may contain polystyrene in amounts of about 5 to about 95 wt % and most often about 25 to about 75 wt %, based on the total weight of the polymers.

In yet another embodiment, polyimides may be used as the organic polymers in the composition. Useful thermoplastic polyimides have the general formula (XVI) 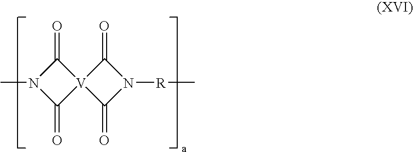
wherein “a” is greater than or equal to about 1, desirably greater than or equal to about 10, and more desirably greater than or equal to about 1000; and wherein V is a tetravalent linker without limitation, as long as the linker does not impede synthesis or use of the polyimide. Suitable linkers include (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations thereof. Suitable substitutions and/or linkers include, but are not limited to, ethers, epoxides, amides, esters, and combinations thereof. Exemplary linkers include but are not limited to tetravalent aromatic radicals of formula (XVII), such as 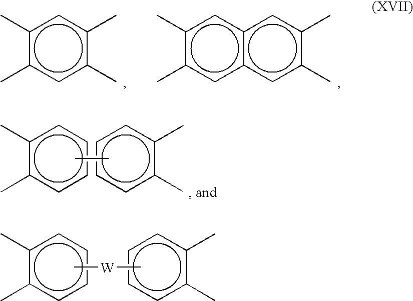
wherein W is a divalent moiety selected from the group consisting of —O—, —S—, —C(O)—, —SO₂—, —SO—, —C_{y}H_{2y}— (y being an integer from 1 to 5), and halogenated derivatives thereof, including perfluoroalkylene groups, or a group of the formula —O—Z—O— wherein the divalent bonds of the —O— or the —O—Z— group are in the 3,3′, 3,4′, 4,3′, or the 4,4′ positions, and wherein Z includes, but is not limited, to divalent radicals of formula (XVIII).

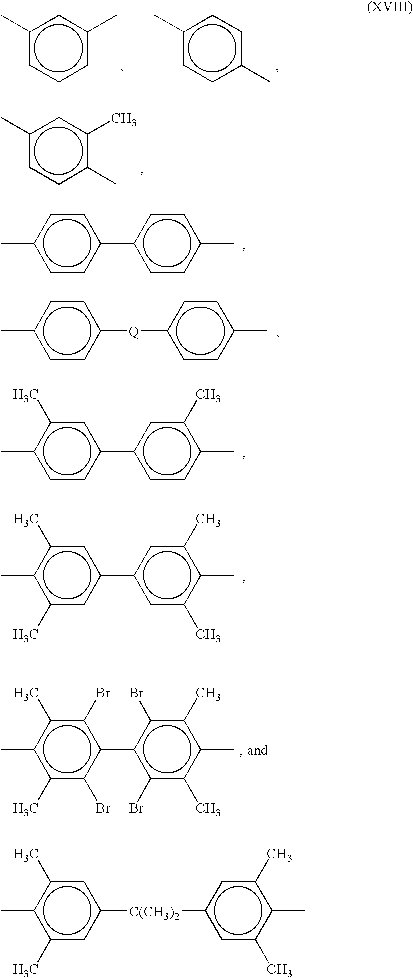

R in formula (XVI) includes substituted or unsubstituted divalent organic radicals such as (a) aromatic hydrocarbon radicals having about 6 to about 20 carbon atoms and halogenated derivatives thereof, (b) straight or branched chain alkylene radicals having about 2 to about 20 carbon atoms; (c) cycloalkylene radicals having about 3 to about 20 carbon atoms, or (d) divalent radicals of the general formula (XIX) 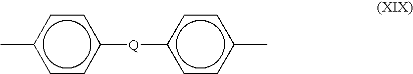
wherein Q includes a divalent moiety selected from the group consisting of —O—, —S—, —C(O)—, —SO₂—, —SO—, —C_{y}H_{2y}— (y being an integer from 1 to 5), and halogenated derivatives thereof, including perfluoroalkylene groups.

Suitable classes of polyimides include polyamidimides and polyetherimides, particularly those polyetherimides that are melt processable.

Suitable polyetherimide polymers comprise more than 1 structural unit of the formula (XX). It is generally desirable for the polyetherimide polymers to contain about 10 to about 1000 structural units of formula (XX). In one embodiment, it is desirable for the polyetherimide polymers to contain about 10 to about 500 structural units, of the formula (XX) 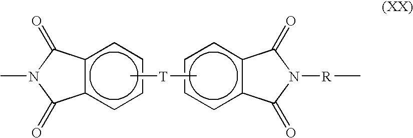
wherein T is —O— or a group of the formula —O—Z—O— wherein the divalent bonds of the —O— or the —O—Z—O— group are in the 3,3′, 3,4′, 4,3′, or the 4,4′positions, and wherein Z includes, but is not limited, to divalent radicals of formula (XVIII) as defined above.

In one embodiment, the polyetherimide may be a copolymer, which, in addition to the etherimide units described above, further contains polyimide structural units of the formula (XXI) 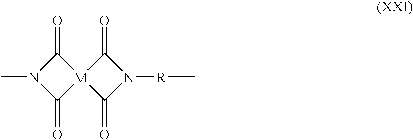
wherein R is as previously defined for formula (XVI) and M includes, but is not limited to, radicals of formula (XXII).

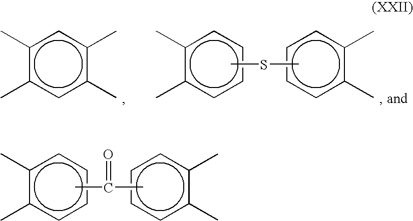

The polyetherimide can be prepared by any of the methods including the reaction of an aromatic bis(ether anhydride) of the formula (XXIII) 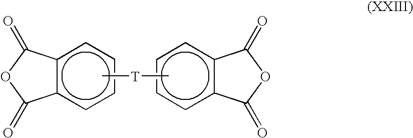
with an organic diamine of the formula (XIV)
H₂N—R—NH₂ (XXIV)
wherein T and R are defined as described above in formulas (XVI) and (XX).

Illustrative examples of aromatic bis(ether anhydride)s of formula (XXIII) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. An exemplary class of aromatic bis(ether anhydride)s included by formula (XXIII) above includes, but is not limited to, compounds wherein T is of the formula (XXV) 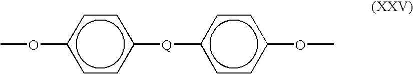
and the ether linkages, for example, are in the 3,3′, 3,4′, 4,3′, or 4,4′ positions, and mixtures thereof, and where Q is as defined above.

Any diamino compound may be employed in the preparation of the polyimides and/or polyetherimides. Examples of suitable compounds are ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl- 1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1,3-diamino-4-isopropylbenzene, bis(4-aminophenyl) sulfide, bis (4-aminophenyl) sulfone, bis(4-aminophenyl) ether and 1,3-bis(3-aminopropyl) tetramethyldisiloxane. Mixtures of these compounds may also be present. Exemplary diamino compounds are aromatic diamines, especially m- and p-phenylenediamine and mixtures thereof.

In an exemplary embodiment, the polyetherimide resin comprises structural units according to formula (XX) wherein each R is independently p-phenylene or m-phenylene or a mixture thereof and T is a divalent radical of the formula (XXVI).

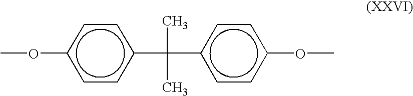

In general, the reactions can be carried out employing solvents such as o-dichlorobenzene, m-cresol/toluene, or the like, to effect a reaction between the anhydride of formula (XVIII) and the diamine of formula (XIX), at temperatures of about 100° C. to about 250° C. Alternatively, the polyetherimide can be prepared by melt polymerization of aromatic bis(ether anhydride)s of formula (XVIII) and diamines of formula (XIX) by heating a mixture of the starting materials to elevated temperatures with concurrent stirring. Generally, melt polymerizations employ temperatures of about 200° C. to about 400° C. Chain stoppers and branching agents may also be employed in the reaction. When polyetherimide/polyimide copolymers are employed, a dianhydride, such as pyromellitic anhydride, is used in combination with the bis(ether anhydride). The polyetherimide polymers can optionally be prepared from reaction of an aromatic bis(ether anhydride) with an organic diamine in which the diamine is present in the reaction mixture at no more than about 0.2 molar excess, and more desirably less than about 0.2 molar excess. Under such conditions the polyetherimide resin has less than about 15 microequivalents per gram (μeq/g) acid titratable groups, and more desirably less than about 10 μeq/g acid titratable groups, as shown by titration with chloroform solution with a solution of 33 weight percent (wt %) hydrobromic acid in glacial acetic acid. Acid-titratable groups are essentially due to amine end-groups in the polyetherimide resin.

Generally, useful polyetherimides have a melt index of about 0.1 to about 10 grams per minute (g/min), as measured by American Society for Testing Materials (ASTM) D1238 at 295° C., using a 6.6 kilogram (kg) weight. In an exemplary embodiment, the polyetherimide resin has a weight average molecular weight (Mw) of about 10,000 to about 150,000 grams per mole (g/mole), as measured by gel permeation chromatography, using a polystyrene standard. Such polyetherimide polymers generally have an intrinsic viscosity greater than about 0.2 deciliters per gram (dl/g), and more desirably in an amount of about 0.35 to about 0.7 dl/g measured in m-cresol at 25° C.

In yet another embodiment, polyamides may be used as the organic polymers in the composition. Polyamides are generally derived from the polymerization of organic lactams having from 4 to 12 carbon atoms. Exemplary lactams are represented by the formula (XXVII) 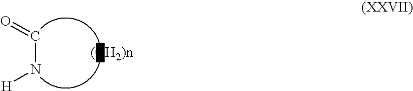
wherein n is about 3 to about 11. An exemplary lactam is epsilon-caprolactam having n equal to 5.

Polyamides may also be synthesized from amino acids having from 4 to 12 carbon atoms. Exemplary amino acids are represented by the formula (XXVIII) 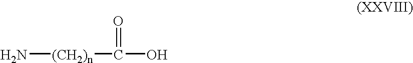
wherein n is about 3 to about 11. An exemplary amino acid is epsilon-aminocaproic acid with n equal to 5.

Polyamides may also be polymerized from aliphatic dicarboxylic acids having from 4 to 12 carbon atoms and aliphatic diamines having from 2 to 12 carbon atoms. Exemplary aliphatic dicarboxylic acids are the same as those described above for the synthesis of polyesters. Exemplary aliphatic diamines are represented by the formula (XXIX)
H₂N—(CH₂)ₙ—NH₂ (XXIX)
wherein n is about 2 to about 12. An exemplary aliphatic diamine is hexamethylenediamine (H₂N(CH₂)₆NH₂). It is desirable for the molar ratio of the dicarboxylic acid to the diamine be about 0.66 to about 1.5. In one embodiment, it is desirable to use molar ratios of about 0.81 to about 1.22. In another embodiment, it is desirable to use molar ratios of about 0.96 to about 1.04. Exemplary polyamides are nylon 6, nylon 6,6, nylon 4,6, nylon 6, 12, nylon 10, or the like, or combinations comprising at least one of the foregoing nylons.

Synthesis of polyamideesters may also be accomplished from aliphatic lactones having from 4 to 12 carbon atoms and aliphatic lactams having from 4 to 12 carbon atoms. The aliphatic lactones are the same as those described above for polyester synthesis, and the aliphatic lactams are the same as those described above for the synthesis of polyamides. The ratio of aliphatic lactone to aliphatic lactam may vary widely depending on the desired composition of the final copolymer, as well as the relative reactivity of the lactone and the lactam. An exemplary initial molar ratio of aliphatic lactam to aliphatic lactone is about 0.5 to about 4. Within this range a molar ratio of greater than or equal to about 1 is desirable. Also desirable is a molar ratio of less than or equal to about 2.

The composition may further comprise a catalyst or an initiator. Generally, any known catalyst or initiator suitable for the corresponding thermal polymerization may be used. Alternatively, the polymerization may be conducted without a catalyst or initiator. For example, in the synthesis of polyamides from aliphatic dicarboxylic acids and aliphatic diamines, no catalyst is required.

For the synthesis of polyamides from lactams, suitable catalysts include water and the omega-amino acids corresponding to the ring-opened (hydrolyzed) lactam used in the synthesis. Other suitable catalysts include metallic aluminum alkylates (MAl(OR)₃H; wherein M is an alkali metal or alkaline earth metal, and R is C₁-C₁₂ alkyl), sodium dihydrobis(2-methoxyethoxy)aluminate, lithium dihydrobis(tert-butoxy)aluminate, aluminum alkylates (Al(OR)₂R; wherein R is C₁-C₁₂ alkyl), N-sodium caprolactam, magnesium chloride or bromide salt of epsilon-caprolactam (MgXC₆H₁₀NO, X═Br or Cl), dialkoxy aluminum hydride. Suitable initiators include isophthaloylbiscaprolactam, N-acetalcaprolactam, isocyanate epsilon-caprolactam adducts, alcohols (ROH; wherein R is C₁-C₁₂ alkyl), diols (HO—R—OH; wherein R is R is C₁-C₁₂ alkylene), omega-aminocaproic acids, and sodium methoxide.

For the synthesis of polyamideesters from lactones and lactams, suitable catalysts include metal hydride compounds, such as a lithium aluminum hydride catalysts having the formula LiAl(H)ₓ(R¹)_{y}, where x is about 1 to about 4, y is about 0 to about 3, x+y is equal to 4, and R¹ is selected from the group consisting of C₁-C₁₂ alkyl and C₁-C₁₂ alkoxy; suitable catalysts include LiAl(H)(OR²)₃, wherein R² is selected from the group consisting of C₁-C₈ alkyl; an especially desirable catalyst is LiAl(H)(OC(CH₃)₃)₃. Other suitable catalysts and initiators include those described above for the polymerization of poly(epsilon-caprolactam) and poly(epsilon-caprolactone).

An exemplary type of polyamide is one obtained by the reaction of a first polyamide and a polymeric material selected from the group consisting of a second polyamide, poly(arylene ether), poly(alkenyl aromatic) homopolymer, rubber modified poly(alkenyl aromatic) resin, acrylonitrile-butadiene-styrene (ABS) graft copolymers, block copolymer, and combinations comprising two or more of the foregoing. The first polyamide comprises repeating units having formula (XXX): 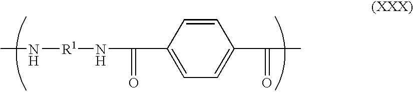
wherein R¹ is a branched or unbranched alkyl group having nine carbons. R¹ may be 1,9-nonane and/or 2-methyl-1,8-octane. Polyamide resins are characterized by the presence of an amide group (—C(O)NH—) which is the condensation product of a carboxylic acid and an amine. The first polyamide is typically made by reacting one or more diamines comprising a nine carbon alkyl moiety with terephthalic acid (1,4-dicarboxy benzene). When employing more than one diamine the ratio of the diamines can affect some of the physical properties of the resulting polymer such as the melt temperature. The ratio of diamine to dicarboxylic acid is typically equimolar although excesses of one or the other may be used to determine the end group functionality. In addition the reaction can further include monoamines and monocarboxylic acids which function as chain stoppers and determine, at least in part, the end group functionality. In one embodiment it is desirable to have an amine end group content of greater than or equal to about 30 meq/g. In one embodiment it is desirable to have an amine end group content of greater than or equal to about 40 meq/g.

The second polyamide comprises repeating units having formula (XXXI) and/or formula (XXXII) 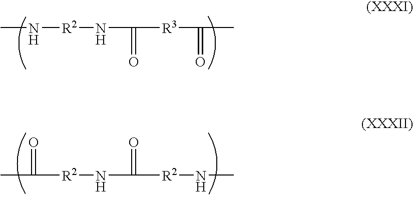
wherein R² is a branched or unbranched alkyl group having four to seven carbons and R³ is an aromatic group having six carbons or a branched or unbranched alkyl group having four to seven carbons. R² can be 1,6-hexane in formula XXXI and 1,5-pentane in formula XXXII. R³ can be 1,4-butane.

The first polyamide has better dimensional stability, temperature resistance, resistance to moisture uptake, abrasion resistance and chemical resistance compared to other polyamides. Hence, electrically conductive compositions comprising the first polyamide exhibit these same improved properties when compared to comparable compositions containing other polyamides in place of the first polyamide. In some embodiments the combination of the first and second polyamide improves the compatibility of the polyamide phase with other phases, such as poly(arylene ether), in multiphasic compositions thereby improving the impact resistance. Without being bound by theory it is believed that the second polyamide increases the amount of available terminal amino groups. The terminal amino groups can, in some instances, react with components of other phases or be functionalized to react with other phases, thereby improving the compatibility.

The organic polymer (including resin blends) is generally used in amounts of about 5 to about 99.999 weight percent (wt %), based on the total weight of the composition. In one embodiment, it is desirable to use organic polymers in an amount of about 10 to about 99.99, based on the total weight of the composition. In another embodiment, it is desirable to use organic polymers in an amount of about 30 to about 99.5, based on the total weight of the composition. In yet another embodiment, it is desirable to use organic polymers in an amount of about 50 to about 99.3, based on the total weight of the composition.

The carbon nanotubes used in the carbon nanotube composition can undergo roping and can be single wall carbon nanotubes (SWNTs) and/or multiwall carbon nanotubes (MWNTs). Carbon nanotubes used in the carbon nanotube composition may be produced by laser-evaporation of graphite, chemical vapor deposition, carbon arc synthesis or the high-pressure carbon monoxide conversion process (HIPCO) process.

The SWNTs generally have a single wall comprising a graphene sheet with outer diameters of about 0.7 to about 2.4 nanometers (nm). It is generally desirable for the SWNTs to have an inherent thermal conductivity of at least 2000 Watts per meter Kelvin (W/m-K) and for the SWNT ropes to have an inherent electrical conductivity of 10⁴ Siemens/centimeter (S/cm). It is also generally desirable for the SWNTs to have a tensile strength of at least 80 gigapascals (GPa) and a stiffness of at least about 0.5 tarapascals (TPa).

In another embodiment, the SWNTs may comprise a mixture of metallic nanotubes and semi-conducting nanotubes. Metallic nanotubes are those that display electrical characteristics similar to metals, while the semi-conducting nanotubes are those that are electrically semi-conducting. In general the manner in which the graphene sheet is rolled up produces nanotubes of various helical structures. Zigzag and armchair nanotubes constitute the two possible confirmations. In order to minimize the quantity of SWNTs utilized in the composition, it is generally desirable to have the metallic nanotubes constitute as large a fraction of the total amount of SWNTs used in the composition. It is generally desirable for the SWNTs used in the composition to comprise metallic nanotubes in an amount of greater than or equal to about 1 wt % of the total weight of the SWNTs. In one embodiment, it is desirable to have metallic nanotubes in an amount of greater than or equal to about 20 wt %, while in another embodiment, it is desirable to have metallic nanotubes in an amount of greater than or equal to about 30 wt % of the total weight of the SWNTs. In yet another embodiment, it is desirable to have metallic nanotubes in an amount of greater than or equal to about 50 wt %, while in another embodiment, it is desirable to have metallic nanotubes in an amount of greater than or equal to about 99.9 wt % of the total weight of the SWNTs.

In certain situations it is generally desirable for the SWNTs used in the composition to comprise semi-conducting nanotubes in an amount of greater than or equal to about 1 wt % of the total weight of the SWNTs. In one embodiment, it is desirable to have the semiconducting nanotubes in an amount of greater than or equal to about 20 wt %, while in another embodiment, it is desirable to have semiconducting nanotubes in an amount of greater than or equal to about 30 wt % of the total weight of the SWNTs. In yet another embodiment, it is desirable to have semiconducting nanotubes in an amount of greater than or equal to about 50 wt %, while in another embodiment, it is desirable to have semiconducting nanotubes in an amount of greater than or equal to about 99.9 wt % of the total weight of the SWNTs.

The MWNTs generally have multiple walls comprising graphene sheet with outer diameters of about 1.4 to about 500 nanometers (nm). MWNTs have at least two graphene layers bound around at least a portion of an inner hollow core. In one embodiment, the MWNTs may have only two graphene layers, while in another embodiment, the MWNTs may have only three graphene layers. MWNTs having only two graphene layers are termed double wall carbon nanotubes, while MWNTs having only three graphene layers are termed triple wall carbon nanotubes. Hemispherical caps generally close both ends of the MWNTs, but it may desirable to use MWNTs having only one hemispherical cap or MWNTs, which are devoid of both caps. It is generally desirable to use MWNTs having average diameters less than or equal to about 40 nm. In one embodiment, it is desirable to use MWNTs having diameters of less than or equal to about 30, while in another embodiment it is desirable to use MWNTs having diameters less than or equal to about 20 nm.

Carbon nanotubes having aspect ratios of greater than or equal to about 5 are generally utilized in the compositions. In one embodiment, the aspect ratio is greater than or equal to 100, while in another embodiment, the aspect ratio is greater than or equal to 1,000. The carbon nanotubes generally comprise a central portion, which is hollow, but may be filled with amorphous carbon.

In an exemplary embodiment, the purpose of dispersion of the carbon nanotubes in an organic polymer is to disentangle the carbon nanotubes so as to obtain an effective aspect ratio that is as close to the aspect ratio of the carbon nanotubes as possible. The ratio of the effective aspect ratio to the aspect ratio is a measure of the effectiveness of dispersion. The effective aspect ratio is a value that is twice the radius of gyration of a single carbon nanotube divided by the outer diameter of the respective individual nanotube. It is generally desirable for the average value of the ratio of the effective aspect ratio to the aspect ratio to be greater than or equal to about 0.5 as measured in an electron micrograph at a magnification of greater than or equal to about 10,000. In one embodiment, it is desirable for the average value of the ratio of the effective aspect ratio to the aspect ratio to be greater than or equal to about 0.75 as measured in an electron micrograph at a magnification of greater than or equal to about 10,000. In another embodiment, it is desirable for the average value of the ratio of the effective aspect ratio to the aspect ratio to be greater than or equal to about 0.9 as measured in an electron micrograph at a magnification of greater than or equal to about 10,000. In yet another embodiment, it is desirable for the average value of the ratio of the effective aspect ratio to the aspect ratio to be greater than or equal to about 1.0 as measured in an electron micrograph at a magnification of greater than or equal to about 10,000.

In an exemplary embodiment, the purpose of dispersion of carbon nanotubes is to disentangle from large aggregates or large ropes so as to form a roped network. It is desirable to have a roped network that percolates the mass of the organic polymer in order to have an electrically conductive composition. Dispersion of the carbon nanotubes should be effective enough to breakdown the large aggregates or large ropes into much smaller ropes, but not so effective that the network cannot be established or destroyed. It is desirable to establish the thinnest possible roped network. For example, in one exemplary embodiment, the ropes that constitute the percolating network would comprise a few carbon nanotubes that may be just a few nanometers thick. These ropes may be highly entangled with one another forming an extensive percolating network.

In one embodiment, in order to achieve an electrically conductive composition, the percolating network can be formed from ropes whose diameters and lengths have been reduced during the process of dispersion. In another embodiment, the percolating network can comprise ropes of carbon nanotubes, individual carbon nanotubes that are not roped, agglomerates of carbon nanotubes that are not dispersed, as well as production related impurities. The point of the contact between the various carbon nanotubes in the network is called a node. The number of nodes can such that the network is not effectively formed (i.e., the agglomerates of carbon nanotubes are not effectively dispersed) and consequently a percolating network is not produced. On the other hand, when too much shear is applied during mixing, the number of nodes is such that once again a percolating network is not produced. It is desirable to disperse the carbon nanotubes to have a number of nodes effective to produce a bulk electrical resistivity of less than or equal to about 10¹² ohm-cm. It is more desirable to disperse the carbon nanotubes to have a number of nodes effective to produce a bulk electrical resistivity of less than or equal to about 10⁸ ohm-cm.

In one embodiment, the composition after melt blending preferably contains the carbon nanotubes in the form of a carbon nanotube network. The carbon nanotube network is preferably a three-dimensional network and facilitates the passage of an electric current through the composition. Electron tunneling may also occur between carbon nanotubes present in the network. Electron tunneling may also occur between the carbon nanotubes and other conductive particles (e.g., carbon black, MWNTs, or the like) in the network. The carbon nanotube network comprises nodes at which either the individual carbon nanotubes or the carbon nanotube ropes make physical contact.

In one embodiment, the carbon nanotubes may exist in the form of rope-like-aggregates. These aggregates are commonly termed “ropes” and are formed as a result of Van der Waal's forces between the individual carbon nanotubes. The individual nanotubes in the ropes may slide against one another and rearrange themselves within the rope in order to minimize the free energy. Ropes generally having between 2 and 10⁵ nanotubes may be used in the compositions. Within this range it is generally desirable to have ropes having greater than or equal to about 10 nanotubes. In another embodiment, it is desirable to have ropes having greater than or equal to about 100 nanotubes. Also desirable are ropes having less than or equal to about 10⁴ nanotubes. In another embodiment, it is desirable to have ropes having less than or equal to about 5000 nanotubes.

Carbon nanotubes are generally used in amounts of about 0.001 to about 50 wt % of the total weight of the electrically conductive composition. In one embodiment, it is desirable to use the nanotubes in amounts of about 0.25 to about 30 wt %, based upon the total weight of the electrically conductive composition. In another embodiment, it is desirable to use the nanotubes in amounts of about 0.50 to about 10 wt %, based upon the total weight of the electrically conductive composition. In another embodiment, it is desirable to use the nanotubes in amounts of about 1.0 to about 5 wt %, based upon the total weight of the electrically conductive composition.

“Production related impurities” as used herein means impurities produced during processes substantially or wholly related to the production of carbon nanotubes. As stated above, carbon nanotubes are produced in processes such as, for example, laser ablation, chemical vapor deposition, carbon arc, high-pressure carbon monoxide conversion process, and the like. Processes substantially or wholly related to the production of carbon nanotubes also involve purification processes for the carbon nanotubes. Production related impurities are those impurities that are either formed naturally or formed deliberately during the production of carbon nanotubes in the aforementioned processes or similar manufacturing processes. An example of production related impurities that are formed naturally are catalyst particles used in the production of the carbon nanotubes. Another example of a production related impurity that is formed deliberately is a dangling bond formed on the surface of the carbon nanotube by the deliberate addition of a small amount of an oxidizing agent during the manufacturing process. Yet another example of a production related impurity is a graphitic nanosheet that may be produced during the production of carbon nanotubes or the purification process for carbon nanotubes.

Production related impurities include for example, carbonaceous reaction by-products such as defective carbon nanotubes, multiwall carbon nanotubes, branched or coiled multiwall carbon nanotubes, amorphous carbon, soot, nano-onions, nanohorns, coke, or the like; catalytic residues from the catalysts utilized in the production process such as metals, metal oxides, metal carbides, metal nitrides or the like, or combinations comprising at least one of the foregoing reaction byproducts. A process that is substantially related to the production of carbon nanotubes is one in which the fraction of carbon nanotubes is larger when compared with any other fraction of production related impurities. In order for a process to be substantially related to the production of carbon nanotubes, the fraction of carbon nanotubes would have to be greater than a fraction of any one of the above listed reaction byproducts or catalytic residues. For example, the fraction of carbon nanotubes would have to be greater than the fraction of soot, or the fraction of carbon black. The fraction of carbon nanotubes would not have to be greater than the sums of the fractions of any combination of production related impurities for the process to be considered substantially directed to the production of carbon nanotubes.

Production related impurities do not include any additives added to the carbon nanotubes either prior to or during the process of manufacturing of the carbon nanotubes wherein such additives do not modify the carbon nanotubes. They also do not include additives added to the carbon nanotubes after the carbon nanotubes are manufactured or purified. Production related impurities also do not include additives added to either the carbon nanotubes or to the organic polymer during the process of manufacturing the electrically conductive composition.

While SWNTs in general have fewer defects than MWNTs (presumably because they have no neighboring walls to compensate for defects by forming bridges between unsaturated carbon valences in these neighboring walls), they do suffer from some defects. Such defects may disrupt the van der Waal's forces between adjacent carbon nanotubes that permit the formation of ropes. Examples of defects in the carbon nanotubes are dangling carbon bonds formed on the wall of the carbon nanotube. Defects wherein the dangling carbon bonds have a first end covalently bonded to another carbon atom on the wall of the carbon nanotube and a second end is bonded to a reactive functional group, wherein such attachment occurs during production of the carbon nanotubes are within the scope of the present invention. Suitable functional groups include, for example, hydroxyl groups, carboxyl groups, halides, especially fluorines, sulfates, nitrates epoxys, anhydrides, esters, amides, and the like. The attachment of such reactive functional groups to defective carbon nanotubes may be by adding appropriate reactants to the reaction chamber in which the carbon nanotubes are produced. It has been found that carbon nanotubes produced by such functionalization during production of the carbon nanotubes yields a different product than carbon nanotubes functionalized after production.

Carbonaceous byproducts such as multiwall carbon nanotubes that do not rope, amorphous carbon, soot, nano-onions, nanohorns, coke, or the like, or combinations comprising at least one of the foregoing are carbonaceous byproducts of the process for production of the carbon nanotubes. Multiwall carbon nanotubes are those having more than a single wall for at least a portion of the length of the nanotube. The walls may have a ‘tree ring’ structure or a ‘fishbone’ structure.

Catalytic residues generally contain the metals used as catalysts in the production of carbon nanotubes. Metals used as catalysts are generally transition metals such as iron, copper, nickel, cobalt, platinum, ruthenium, rhodium, palladium, osmium, iridium, platinum, chromium, molybdenum and tungsten or the like, or a combination comprising at least one of the foregoing metals. Non-transition metals may also be used as catalysts. Suitable examples of such non-transition metals are aluminum, indium, or the like, or combinations comprising at least one of the foregoing non-transition metals. In one embodiment, impurities formed during the manufacturing of the carbon nanotubes are metal oxides such as iron oxides, nickel oxides, cobalt oxides, or the like, or combinations comprising at least one of the foregoing oxides. Suitable examples of metal carbide impurities include iron carbide, tungsten carbide, or the like, or combinations comprising at least one of the foregoing metal carbides.

In general, the carbon nanotube composition may comprise about 0.1 to about 80 wt % impurities, based on the total weight of the carbon nanotube composition. In one embodiment, the carbon nanotube composition may comprise about 3 to about 50 wt % impurities, based on the total weight of the carbon nanotube composition. In another embodiment, the carbon nanotube composition may comprise about 7 to about 45 wt % impurities, based on the total weight of the carbon nanotube composition. In yet another embodiment, the carbon nanotube composition may comprise about 8 to about 40 wt % impurities, based on the total weight of the carbon nanotube composition.

In one embodiment, the carbon nanotube composition may comprise an amount of about 0.1 to about 50 wt % catalytic residues based on the total weight of the carbon nanotube composition. In one embodiment, the carbon nanotube composition may comprise about 3 to about 48 wt % catalytic residues, based on the total weight of the carbon nanotube composition. In another embodiment, the carbon nanotube composition may comprise about 7 to about 45 wt % catalytic residues, based on the total weight of the carbon nanotube composition. In yet another embodiment, the carbon nanotube composition may comprise about 8 to about 40 wt % catalytic residues, based on the total weight of the carbon nanotube composition.

Other conductive fillers such as VGCF, carbon black, conductive metallic fillers, solid non-metallic, conductive fillers, graphitic nanosheets (GNS's), or the like, or combinations comprising at least one of the foregoing may optionally be used in the compositions. VGCF are small graphitic or partially graphitic carbon fibers, having diameters of about 3.5 to about 2000 nm and an aspect ratio greater than or equal to about 5. When VGCF are used, it is desirable to use diameters of about 3.5 to about 500 nm. In another embodiment, it is desirable to use VGCF having diameters of about 3.5 to about 100 nm. In yet another embodiment, it is desirable to use VGCF having diameters of about 3.5 to about 50 nm. It is also desirable to have average aspect ratios greater than or equal to about 100. In one embodiment, it is desirable to use VGCF having aspect ratios of greater than or equal to about 1000.

VGCF are generally used in amounts of about 0.001 to about 50 wt % of the total weight of the electrically conductive composition. In one embodiment, the composition may comprise about 0.25 to about 30 wt % VGCF, based on the total weight of the electrically conductive composition. In one embodiment, the composition may comprise about 0.5 to about 10 wt % VGCF, based on the total weight of the electrically conductive composition. In one embodiment, the composition may comprise about 1 to about 5 wt % VGCF, based on the total weight of the electrically conductive composition.

The carbon nanotubes utilized in the electrically conductive composition may also be derivatized after their production with functional groups to improve compatibility and facilitate the mixing with the organic polymer. The carbon nanotubes may be functionalized on either the graphene sheet constituting the sidewall, a hemispherical cap or on both the side wall as well as the hemispherical endcap. Functionalized carbon nanotubes are those having the formula (XXXIII) 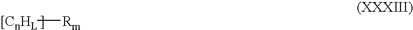
wherein n is an integer, L is a number less than 0.1 n, m is a number less than 0.5 n, and wherein each of R is the same and is selected from —SO₃H, —NH₂, —OH, —C(OH)R′, —CHO, —CN, —C(O)Cl, —C(O)SH, —C(O)OR′, —SR′, —SiR₃′, —Si(OR′)_{y}R′_{(3-y)}, —R″, —AlR₂′, halide, ethylenically unsaturated functionalities, epoxide functionalities, or the like, wherein y is an integer equal to or less than 3, R′ is hydrogen, alkyl, aryl, cycloalkyl, araalkyl, cycloaryl, poly(alkylether), or the like and R″ is fluoroalkyl, fluoroaryl, fluorocycloalkyl, fluoroaralkyl, cycloaryl, or the like. The carbon atoms, Cₙ, are surface carbons of a carbon nanotube.

Non-uniformly substituted carbon nanotubes may also be used in the electrically conductive composition. These include compositions of the formula (XXXIII) shown above wherein n, L, m, R and the carbon nanotube itself are as defined above, provided that each of R does not contain oxygen, or, if each of R is an oxygen-containing group, COOH is not present.

Also included are functionalized carbon nanotubes having the formula (XXXIV) 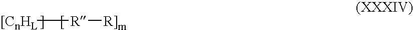
where n, L, m, R′ and R have the same meaning as above. Most carbon atoms in the surface layer of a carbon nanotube are basal plane carbons. Basal plane carbons are relatively inert to chemical attack. At defect sites, where, for example, the graphitic plane fails to extend fully around the carbon nanotube, there are carbon atoms analogous to the edge carbon atoms of a graphite plane. The edge carbons are reactive and must contain some heteroatom or group to satisfy carbon valency.

The substituted carbon nanotubes described above may advantageously be further functionalized. These can include nanotubes of the formula (XXXV) 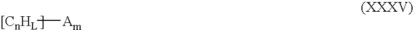
where n, L and m are as described above, A is selected from —OY, —NHY, —CR′₂—OY, —C(O)OY, —C(O)NR′Y, —C(O)SY, or —C(O)Y, wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from —R′OH, —R′NH₂, —R′SH, —R′CHO, —R′CN, —R′X, —R′SiR′₃, —RSi—(OR′)_{y}—R′_{(3-y)}, —R′Si—(O—SiR′₂)—OR′, —R′—R″, —R′—NCO, (C₂H₄O)_{w}Y, —(C₃H₆O)_{w}H, —(C₂H₄O)_{w}R′, —(C₃H₆O)_{w}R′ and R″, wherein w is an integer greater than one and less than 200.

The functional carbon nanotubes of structure (XXXIV) may also be functionalized to produce nanotubes having the formula (XXXV) 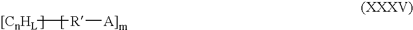
where n, L, m, R′ and A are as defined above.

The nanotubes also include other carbon nanotubes upon which certain cyclic compounds are adsorbed. These include nanotubes having the formula (XXXVII) 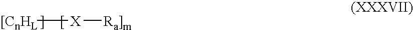
where n is an integer, L is a number less than 0.1 n, m is less than 0.5 n, a is zero or a number less than 10, X is a polynuclear aromatic, polyheteronuclear aromatic or metallopolyheteronuclear aromatic moiety and R is as recited above. Exemplary cyclic compounds are planar macrocycles such as re porphyrins and phthalocyanines.

The adsorbed cyclic compounds may be functionalized. Such compositions include compounds of the formula (XXXVIII) 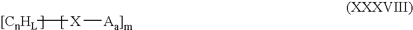
where m, n, L, a, X and A are as defined above and the carbons are on the carbon nanotube.

Without being bound to a particular theory, the functionalized carbon nanotubes are better dispersed into organic polymers because the modified surface properties may render the carbon nanotube more compatible with the organic polymer, or, because the modified functional groups (particularly hydroxyl or amine groups) are bonded directly to the organic polymer as terminal groups. In this way, organic polymers such as polycarbonates, polyamides, polyesters, polyetherimides, or the like, bond directly to the carbon nanotubes, thus making the carbon nanotubes easier to disperse with improved adherence to the organic polymer.

Functional groups may generally be introduced onto the outer surface of the carbon nanotubes by contacting the respective outer surfaces with a strong oxidizing agent for a period of time sufficient to oxidize the surface of the carbon nanotubes and further contacting the respective outer surfaces with a reactant suitable for adding a functional group to the oxidized surface. Exemplary oxidizing agents are comprised of a solution of an alkali metal chlorate in a strong acid. Exemplary alkali metal chlorates are sodium chlorate or potassium chlorate. An exemplary strong acid used is sulfuric acid. Periods of time sufficient for oxidation are about 0.5 hours to about 24 hours.

Carbon black may also be optionally used in the electrically conductive compositions. Exemplary carbon blacks are those having average particle sizes less than about 200 mn, more desirably less than about 100 nm, and most desirably less than about 50 nm. Exemplary conductive carbon blacks may also have surface areas greater than about 200 square meter per gram (m²/g), more desirably greater than about 400 m²/g, and most desirably greater than about 1000 m²/g. Exemplary conductive carbon blacks may have a pore volume (dibutyl phthalate absorption) greater than about 40 cubic centimeters per hundred grams (cm3/100 g), more desirably greater than about 100 cm³/100 g, and most desirably greater than about 150 cm³/100 g. Exemplary carbon blacks include the carbon black commercially available from Columbian Chemicals under the trade name Conductex®; the acetylene black available from Chevron Chemical, under the trade names S.C.F. (Super Conductive Furnace) and E.C.F. (Electric Conductive Furnace); the carbon blacks available from Cabot Corp. under the trade names Vulcan XC72 and Black Pearls; and the carbon blacks commercially available from Akzo Co. Ltd under the trade names Ketjen Black EC 300 and EC 600. Exemplary conductive carbon blacks may be used in amounts from about 2 wt % to about 25 wt % based on the total weight of the electrically conductive composition.

Solid conductive metallic fillers may also optionally be used in the electrically conductive composition. These may be electrically conductive metals or alloys that do not melt under conditions used in incorporating them into the organic polymer, and fabricating finished articles therefrom. Metals such as aluminum, copper, magnesium, chromium, tin, nickel, silver, iron, titanium, and mixtures comprising any one of the foregoing metals can be incorporated into the organic polymer as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin-oxide, indium tin oxide, and the like may also optionally be added to render the organic polymer conductive. The solid metallic and non-metallic conductive fillers may exist in the form of powder, drawn wires, strands, fibers, tubes, nanotubes, flakes, laminates, platelets, ellipsoids, discs, and other commercially available geometries commonly known in the art.

Non-conductive, non-metallic fillers that have been coated over a substantial portion of their surface with a coherent layer of solid conductive metal may also optionally be used in the electrically conductive compositions. The non-conductive, non-metallic fillers are commonly referred to as substrates, and substrates coated with a layer of solid conductive metal may be referred to as “metal coated fillers”. Typical conductive metals such as aluminum, copper, magnesium, chromium, tin, nickel, silver, iron, titanium, and mixtures comprising any one of the foregoing metals may be used to coat the substrates. Examples of substrates are well known in the art and include those described in “Plastic Additives Handbook, 5^{th} Edition” Hans Zweifel, Ed, Carl Hanser Verlag Publishers, Munich, 2001. Non-limiting examples of such substrates include silica powder, such as fused silica and crystalline silica, boron-nitride powder, boron-silicate powders, alumina, magnesium oxide (or magnesia), wollastonite, including surface-treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, and kaolin comprising various coatings known in the art to facilitate compatibility with the polymeric matrix resin, mica, feldspar, silicate spheres, flue dust, cenospheres, finite, aluminosilicate (armospheres), natural silica sand, quartz, quartzite, perlite, tripoli, diatomaceous earth, synthetic silica, and mixtures comprising any one of the foregoing. All of the above substrates may be coated with a layer of metallic material for use in the electrically conductive composition.

Regardless of the exact size, shape and composition of the solid metallic and non-metallic conductive filler particles, they may be dispersed into the organic polymer at loadings of about 0.001 to about 50 wt % of the total weight of the electrically conductive composition when desired. In one embodiment, the composition may comprise about 1 to about 50 wt % solid metallic and non-metallic conductive filler particles, based on the total weight of the electrically conductive composition. In another embodiment, the carbon nanotube composition may comprise about 1.5 to about 30 wt % solid metallic and non-metallic conductive filler particles, based on the total weight of the electrically conductive composition. In yet another embodiment, the carbon nanotube composition may comprise about 2 to about 25 wt % solid metallic and non-metallic conductive filler particles, based on the total weight of the electrically conductive composition.

The GNS's used in the electrically conductive composition are generally developed during the purification process for carbon nanotubes and can comprise carbon sheets arranged parallel to one another in a stack. The stack may have any geometrical shape with an aspect ratio of greater than or equal to about 1 such as cubical, plate-like, columnar, cylindrical, and the like. The aspect ratio of the stack prior to processing is greater than or equal to about 5, greater than or equal to about 10, greater than or equal to about 50, and more desirably greater than or equal to about 100.

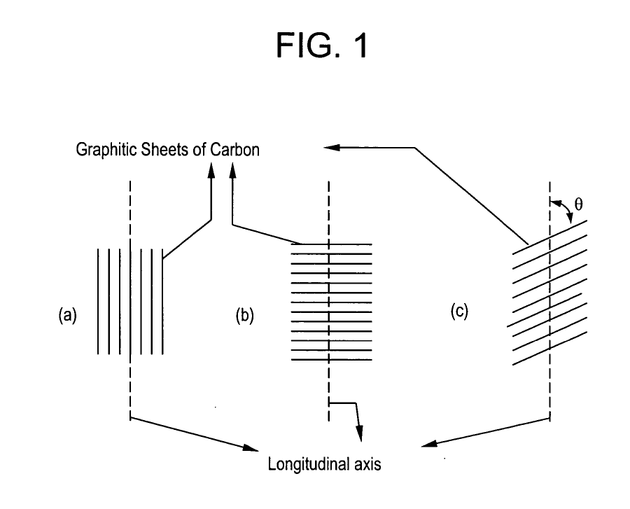

The stack generally comprises sheets of carbon, arranged parallel to each other. The spacing between the carbon sheets is generally about 3.35 Angstroms to about 4.0 Angstroms. In one embodiment, the individual sheets of carbon are arranged parallel to the longitudinal axis of the stack as shown in FIG. 1. In another embodiment, the individual sheets of carbon are arranged perpendicular to the longitudinal axis of the stack. In yet another embodiment, the individual sheets of carbon are arranged at an angle θ of about 1 to about 179 degrees to the longitudinal axis of the stack. In yet another embodiment, a stack may have at least one sheet of carbon arranged parallel to the longitudinal axis, with at least one sheet of carbon arranged perpendicular to the longitudinal axis, with at least one sheet arranged at an angle θ of about 1 to about 179 degrees to the longitudinal axis of the stack.

The stack may generally have a width and breadth of about 0.5 nanometers (nm) to about 1000 nanometer respectively. Within this range the width and breadth may generally be greater than or equal to about 2, and greater than or equal to about 5 mn. Also desirable within this range are widths and breadths less than or equal to about 500, more desirably less than or equal to about 100, and more desirably less than or equal to about 50 nanometers.

In one embodiment, the cross-sectional area of the stack in a plane perpendicular to the longitudinal axis may have different shapes. Examples of such shapes are square, rectangular, rhombohedral, polygonal (e.g., having more than 4 sides), circular, elliptical, or the like, or combinations comprising at least one of the foregoing shapes.

The stack may be substantially straight or it may be kinked or bent. A substantially straight stack generally has an aspect ratio of greater than or equal to about 2, more desirably greater than or equal to about 3, and most desirably greater than or equal to about 5 between bends or kinks.

The organic polymer together with the carbon nanotubes comprising the production related impurities and any other optionally desired conductive fillers such as the carbon black, solid metallic and non-metallic conductive filler particles may generally be processed in several different ways such as, but not limited to melt blending, solution blending, or the like, or combinations comprising at least one of the foregoing methods of blending. Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing.

Melt blending involving the aforementioned forces may be conducted in machines such as, but not limited to single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines.

In one embodiment, the organic polymer in powder form, pellet form, sheet form, or the like, may be first dry blended with the carbon nanotube composition and other optional fillers if desired in a Henschel or a roll mill, prior to being fed into a melt blending device such as an extruder or Buss kneader. While it is generally desirable for the shear forces in the melt blending device to generally cause a dispersion of the carbon nanotube composition in the organic polymer, it is also desired to preserve the aspect ratio of the carbon nanotubes during the melt blending process. In order to do so, it may be desirable to introduce the carbon nanotube composition into the melt blending device in the form of a masterbatch. In such a process, the masterbatch may be introduced into the melt blending device downstream of the organic polymer.

A melt blend is one where at least a portion of the organic polymer has reached a temperature greater than or equal to about the melting temperature, if the resin is a semi-crystalline organic polymer, or the flow point (e.g., the glass transition temperature) if the resin is an amorphous resin during the blending process. A dry blend is one where the entire mass of organic polymer is at a temperature less than or equal to about the melting temperature if the resin is a semi-crystalline organic polymer, or at a temperature less than or equal to the flow point if the organic polymer is an amorphous resin and wherein organic polymer is substantially free of any liquid-like fluid during the blending process. A solution blend, as defined herein, is one where the organic polymer is suspended in a liquid-like fluid such as, for example, a solvent or a non-solvent during the blending process.

When a masterbatch is used, the carbon nanotube composition may be present in the masterbatch in an amount of about 1 to about 50 wt %, based on the total weight of the masterbatch. In one embodiment, the masterbatch can comprise about 1.5 to about 30 wt % of the carbon nanotube composition, based on the total weight of the masterbatch. In another embodiment, the masterbatch can comprise about 2 to about 10 wt % of the carbon nanotube composition, based on the total weight of the masterbatch. In yet another embodiment, the masterbatch can comprise about 2.5 to about 5 wt % of the carbon nanotube composition, based on the total weight of the masterbatch.

In one embodiment pertaining to the use of masterbatches, while the masterbatch containing the carbon nanotube composition may not have a measurable bulk or surface resistivity either when extruded in the form of a strand or molded into the form of dogbone, the resulting composition into which the masterbatch is incorporated has a measurable bulk or surface resistivity, even though the weight fraction of the carbon nanotubes in the composition is lower than that in the masterbatch. In another embodiment pertaining to the use of masterbatches, the masterbatch containing the carbon nanotube composition will have a measurable bulk or surface resistivity that is less than the resulting composition into which the masterbatch is incorporated, even though the weight fraction of the carbon nanotubes in the composition is lower than that in the masterbatch.

It is preferable for the organic polymer in such a masterbatch to be semi-crystalline. Examples of semi-crystalline organic polymers which display these characteristics and which may be used in masterbatches are polypropylene, polyamides, polyesters, or the like, or combinations comprising at least on of the foregoing semi-crystalline organic polymers.

In another embodiment relating to the use of masterbatches in the manufacture of an electrically conductive composition comprising a blend of organic polymers, it is sometimes desirable to have the masterbatch comprising an organic polymer that is the same as the organic polymer that forms the continuous phase of the electrically conductive composition. This feature permits the use of substantially smaller proportions of the carbon nanotubes, since only the continuous phase carries the carbon nanotubes that provide the electrically conductive composition with the requisite volume and surface resistivity. In yet another embodiment relating to the use of masterbatches in polymeric blends, it may be desirable to have the masterbatch comprising an organic polymer that is different in chemistry from the other organic polymers that are used in the electrically conductive composition. In this case, the organic polymer of the masterbatch will form the continuous phase in the blend. In yet another embodiment, it may be desirable to use a separate masterbatch comprising multiwall nanotubes that do not rope, vapor grown carbon fibers, carbon black, conductive metallic fillers, solid non-metallic, conductive fillers, or the like, or combinations comprising at least one of the foregoing in the masterbatch.

The electrically conductive composition comprising the organic polymer and the carbon nanotube composition may be subject to multiple blending and forming steps if desirable. For example, the electrically conductive composition may first be extruded and formed into pellets. The pellets may then be fed into a molding machine where it may be formed into other desirable shapes such as housing for computers, automotive panels that can be electrostatically painted, or the like. Alternatively, the electrically conductive composition emanating from a single melt blender may be formed into sheets or strands and subjected to post-extrusion processes such as annealing, uniaxial or biaxial orientation.

In one embodiment involving the use of post-processing, the electrically conductive composition is further subjected to ultradrawing in the unaxial direction utilizing draw ratios of about 2 to about 1,000,000. The high ultradraw ratio generally facilitates the formation of shish-kebab semi-crystalline structures, which may contain carbon nanotubes in the amorphous regions. In another embodiment, the electrically conductive composition is further stressed uniaxially or, biaxially to produce a film having a thickness of about 0.01 micrometers to about 5000 micrometers. If the film comprises a semi-crystalline organic polymer, it is generally desirable for the oriented film to have crystals oriented in the azimuthal direction of about θ=0 degrees to about θ=80 degrees. In yet another embodiment related to post-processing after melt blending, the composition is supercooled to a temperature of about 1° C. to about 100° C. below the melting point after the blending for a time period of about 2 minutes to about 2 hours. The supercooled electrically conductive compositions may generally have macroscopic semi-crystalline structures such as spherulites, which comprise carbon nanotubes.

In semi-crystalline polymers, the carbon nanotubes may behave as nucleating agents. In order to improve the strength of the electrically conductive composition, it may be desirable to have the crystallites nucleate on the carbon nanotubes. In general it is desirable to have at least 1 wt % of the crystallites nucleate on the carbon nanotubes. In one embodiment, it is desirable to have at least 10 wt % crystallites nucleate on the nanotubes, while in another embodiment, it is desirable to have at least 15 wt % of the crystallites nucleate on the carbon nanotubes. In an exemplary embodiment, with regard to the use of nucleating agents, it has been observed that the use of nucleating agents (both carbon nanotube nucleating agents and other nucleating agents) can act to improve the electrical performance of compositions containing carbon nanotubes. By altering the way the crystal structures set up, a more conductive network can be set up. The conductive network can then setup a more continuous structure, which will exhibit lower electrical resistance than a similar composition without the nucleating agents.

Solution blending may also be used to manufacture the electrically conductive composition. The solution blending may also use additional energy such as shear, compression, ultrasonic vibration, or the like, to promote homogenization of the carbon nanotubes with the organic polymer. In one embodiment, an organic polymer suspended in a fluid may be introduced into an ultrasonic sonicator along with the carbon nanotubes. The mixture may be solution blended by sonication for a time period effective to disperse the carbon nanotubes onto the organic polymer particles. The organic polymer along with the carbon nanotubes may then be dried, extruded and molded if desired. It is generally desirable for the fluid to swell the organic polymer during the process of sonication. Swelling the organic polymer generally improves the ability of the carbon nanotubes to impregnate the organic polymer during the solution blending process and consequently improves dispersion.

In another embodiment related to solution blending, the carbon nanotube composition is sonicated together with organic polymer precursors. Organic polymer precursors can be monomers, dimers, trimers, or the like, which can be reacted to form organic polymers. A fluid such as a solvent may optionally be introduced into the sonicator with the carbon nanotubes and the organic polymer precursor. The time period for the sonication is generally an amount effective to promote encapsulation of the carbon nanotubes by the organic polymer precursor. After the encapsulation, the organic polymer precursor is then polymerized to form an organic polymer within which is dispersed the carbon nanotube composition. This method of dispersion of the carbon nanotube composition into the organic polymer promotes the preservation of the aspect ratios of the carbon nanotubes, which therefore permits the composition to develop electrical conductivity at lower loading of the carbon nanotubes. Alternatively, the organic polymer containing encapsulated carbon nanotube composition may be used as a masterbatch, i.e., blended with further organic polymer. In still another embodiment, a mixture of organic polymer, organic polymer precursor, optional fluid and carbon nanotube composition is sonicated to encapsulate the carbon nanotubes, followed by polymerization of the organic polymer precursor.

Suitable examples of organic polymer precursors that may be used to facilitate this method of encapsulation and dispersion are those used in the synthesis of thermoplastic resins such as, but not limited to polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, or the like. In general, it is desirable to sonicate the above-described mixtures for about 1 minute to about 24 hours. In one embodiment, it is desirable to sonicate the above-described mixtures for about 5 minutes to about 15 hours. In another embodiment, it is desirable to sonicate the above-described mixtures for about 10 minutes to about 10 hours. In yet another embodiment, it is desirable to sonicate the above-described mixtures for about 15 minutes to about 5 hours.

In one embodiment, the carbon nanotube compositions having a higher fraction of impurities may be dispersed using less energy than carbon nanotube compositions having a lower fraction of impurities. Without being limited by theory, it is believed that in certain organic polymers, the impurities interact to promote a reduction in the van der Waal's forces thereby facilitating an easier dispersion of the nanotubes within the organic polymer.

In another embodiment, the carbon nanotube compositions having a lower fraction of impurities may be dispersed using more energy than carbon nanotube compositions having a higher fraction of impurities. In general, carbon nanotube compositions having impurities may require different amounts of mixing than those compositions having no impurities. These electrically conductive composition may be used in applications where there is a need for a superior balance of flow, impact, and conductivity. They may also be used in applications where conductive materials are used and wherein the conductive materials possess very small levels of conductive filler such as in fuel cells, electrostatic painting applications, and the like.

The electrically conductive composition described above may be used in a wide variety of commercial applications. They may be advantageously utilized as films for packaging electronic components such as computers, electronic goods, semi-conductor components, circuit boards, or the like which need to be protected from electrostatic dissipation. They may also be used internally inside computers and other electronic goods to provide electromagnetic shielding to personnel and other electronics located outside the computer as well as to protect internal computer components from other external electromagnetic interference. They may also be used advantageously in automotive body panels both for interior and exterior components of automobiles that can be electrostatically painted if desired.

The following examples, which are meant to be exemplary, not limiting, illustrate electrically conductive composition and methods of manufacturing of some of the various embodiments of the electrically conductive compositions described herein.

### EXAMPLE 1

This example demonstrates the effect of shear and as well as the effects of impurities on the level of conductivity that may be attained when carbon nanotube compositions are blended with thermoplastic resins. In this example, a polycarbonate resin having a number average molecular weight of about 17,000 grams/mole and a weight average molecular weight of Mw about 41,000 was blended with 1 wt % of carbon nanotubes in a DACA mini twin screw extruder. The DACA mini twin screw extruder has a maximum mixing volume of 5 cubic centimeters and has a screw speed of from about 10 to about 360 rpm which is digitally controllable in 1 rpm increments. The carbon nanotube compositions contained either 3 wt % or 10 wt % impurities. Carbon nanotube compositions containing 3 wt % impurities are termed SWNT-3, while those containing 10 wt % impurities are termed SWNT-10.

These impurity levels were determined by thermogravimetric analysis (TGA) wherein the sample was burned while the remaining weight in the instrument generally constitutes impurities. In order to determine a more accurate analysis of the impurities, the 2 samples were analyzed via XRF (X-Ray fluorescence) to determine the impurity composition and content. The impurity content is shown in Table 1a.

The extruder screw speed was adjusted to be either 75, 150 or 300 rpm. The extruder temperature was 285° C. The conductivity of the extruded samples was measured at mixing intervals of 1, 3, 5, 7, and 10 minutes. The mixing intervals of about 1 to about 2 minutes are approximately similar to the residence time in the extruder. The extruded strands were then used for electrical specific volume resistivity measurements. Specific volume resistivity (SVR) measurements are shown in Table 1b and 2 for the compositions containing the SWNT-3 and SWNT-10 carbon nanotube compositions respectively.

TABLE 1(a)

| Element | SWNT-3 | SWNT-10 |
|---|---|---|
| Carbon | 99 | 85 |
| Magnesium | 0.02 | 0.03 |
| Aluminum | 0.004 | 0.04 |
| Silicon | 0.03 | 0.09 |
| Phosphorus | 0.01 | 0.005 |
| Sulfur | 0.04 | 0.1 |
| Chlorine | 0.3 | 4 |
| Calcium | 0.004 | 0.03 |
| Chromium | 0 | 0.01 |
| Iron | 0.3 | 11 |
| Nickel | 0 | 0.03 |
| Copper | 0 | 0.3 |
| Molybdenum | 0.007 | 0.03 |
| Total | 99.7 | 100.7 |

Note:
relatively uncertainty for each impurity element found is at least +/−10%.

From the above table, it may be seen that for the compositions containing SWNT-10, most of the impurities are iron, which is used as a catalyst in the production of the carbon nanotubes.

TABLE 1(b)

| | Resistivities (Ohm-cm) at | | | | |
|---|---|---|---|---|---|
| | different mixing times | | | | |
| RPM | 1 min | 3 min | 5 min | 7 min | 10 min |
| 75 | 15,298 | 10,718 | 7,744 | 13,529 | 13,294 |
| 150 | 7,353 | 6,550 | 37,918 | 70,782 | 91,215 |
| 300 | 6,626 | 5,555 | 101,088 | — | — |

TABLE 2

| | Resistivities (Ohm-cm) at | | | | |
|---|---|---|---|---|---|
| | processing mixing times | | | | |
| RPM | 1 min | 3 min | 5 min | 7 min | 10 min |
| 75 | — | — | — | 43,372 | 29,373 |
| 150 | — | 494,381 | 44,706 | 48,851 | 90,673 |
| 300 | — | 26,420 | 4,365 | 6,387 | 37,188 |

As may be seen from the Tables 1(b) and 2, carbon nanotube compositions having smaller weight percentages of impurities, generally utilize less mixing in order to display conductivity. These carbon nanotube compositions establish a roped network much faster, and with much less effort than carbon nanotube compositions with higher impurities. However, from Table 1(b) it may be seen that the carbon nanotube composition containing 3 wt % impurities shows decreasing levels of conductivity when it was mixed for 5 minutes and further showed no conductivity when mixed at 300 rpm for 7 minutes. This indicates that it is possible for the lower impurity carbon nanotube composition to be over-dispersed to the point where the composition loses its conductivity. These carbon nanotube compositions are dispersed to the point where the roped network falls apart. Thus it may be seen that additional mixing time in the DACA mini twin screw extruder may result in lower conductivity for carbon nanotube compositions containing a smaller amount of impurities.

Without being limited by theory, the highly pure carbon nanotube compositions (SWNT-3) are able to set up a conductive network quickly, but additional compounding tends to decrease the conductivity, as seen by the increasing resistivities at 7 and 10 minutes for the 150 and 300 rpm cases in Table 1(b). At the lower mixing speed of 75 rpm, it is believed that the process is controlled by diffusion, i.e., the diffusion of the organic polymer into the carbon nanotubes promotes a separation from the ropes, which promotes dispersion. It is believed that at the lower revolutions per minute (rpm) setting, there is not enough shear force to promote a high degree of entanglements.

The results in Table 2 reflect a different scenario for the composition containing the SWNT-10. At the 1 minute mixing time, there is not enough energy provided to break up the very large agglomerates of greater than or equal to about 10,000 ropes. However increasing the rpm setting from 75 to 150 to 300 shows an improvement in the conductivity (lower resistance) at 3, 5 and 7 minutes mixing time. Additional shear at 3, 5 and 7 minutes helps break down the large aggregates of carbon nanotubes into a roped network that is well connected. The connectivity is responsible for the conductivity of the composite. Additional compounding beyond 7 minutes shows that the network tends to fall apart. The roped network starts to collapse, leading to lower electrical conductivity. This process leads to a network that does not percolate throughout the mass of the organic polymer, and thus lower conductivities result. This behavior is not seen at the lowest rpm settings because the forced entanglement is not created at such low rpm settings.

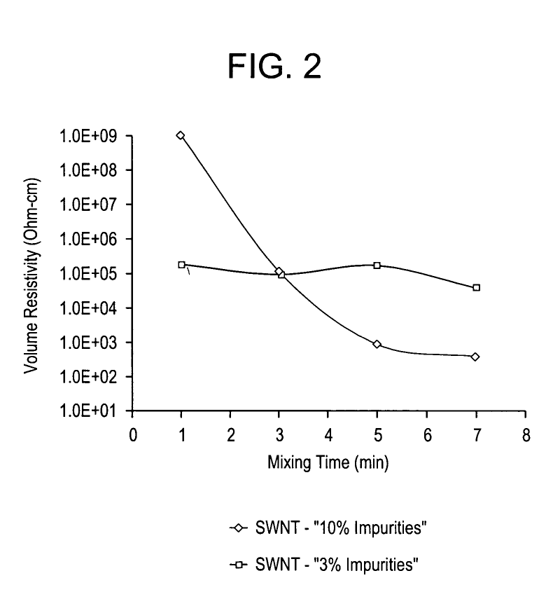

Similar data is presented for a 3% carbon nanotube composition/nylon 6,6 mixture in which the bulk resistivity was measured as a function of mixing time, using the DACA extruder. Additional mixing time helps the less pure carbon nanotube compositions disperse more effectively, where the conductivity remains relatively the same for the 3% impurity (highly pure case). The data is also shown in the FIG. 2, where volume resistivity is plotted against mixing time for a 3 wt % carbon nanotube composition/nylon 6,6 mixture with 2 different types of nanotubes: highly purified and less pure. Both curves were made on the DACA mini-twin screw extruder using an RPM setting of 150 at a temperature of 285° C. The samples were obtained from the strands and the strands were fractured with liquid nitrogen and painted with a silver conductive paint and the resistance was measured with a Fluke multimeter.

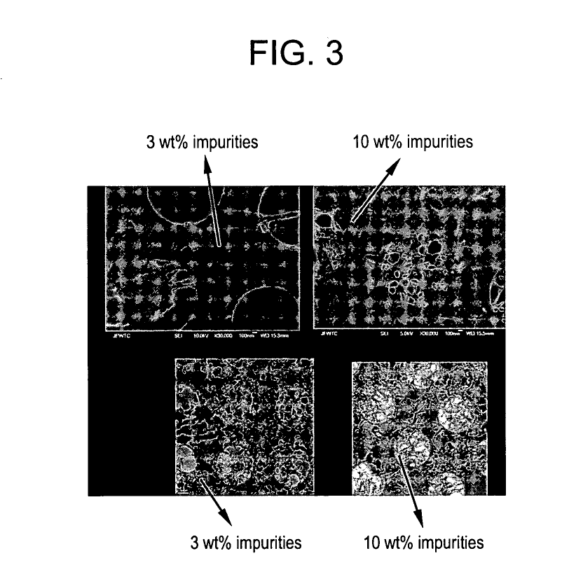

The difference in the dispersion is shown by the micrographs in FIG. 3. The specific volume resistivity for the compositions containing SWNT-10 is 382 ohm-cm while the SVR for the composition containing SWNT-3 is 38240 ohm-cm. The sample containing the lower impurities show a more highly entangled carbon nanotube structure, which leads to a higher resistivity. The open network carbon nanotube structure shown in the micrograph for the compositions containing SWNT-10 is desired in order to obtain satisfactory electrical properties.

The results also indicate that the lower the level of impurities in a given carbon nanotube composition, the more difficult it will be to initially achieve electrical performance. However, upon using additional mixing, it may be seen that in the composition containing SWNT-10, approximately the same level of conductivity as is achieved as in the composition containing SWNT-3.

It can also be seen that as the amount of mixing is increased, there is generally first a decrease in the level of conductivity followed by an increase, indicating that with increased mixing (i.e., mixing for time periods greater than 7 minutes), the carbon nanotubes are being dispersed to the point where there is reduced contact between conductive domains of the carbon nanotube. It may also be possible that as mixing is increased, the carbon nanotubes are becoming more entangled or agglomerated thereby promoting a reduction in the connectivity of the network. In other words, without being limited by theory, it may be postulated that there is an optimum level of energy that needs to be imparted to a given composition in order to obtain the lowest resistivity.

### EXAMPLE 2

This experiment was conducted to determine the effect of mixing on the molecular weight of the resin and on the SVR of the resulting blend. In this example, a polycarbonate resin was blended with 1 wt % of the carbon nanotube composition in the DACA mini twin screw extruder for time periods of about 1 minute to about 10 minutes. The compositions as well as the method of manufacture were similar to those used in Example 1. The test methods employed were similar to those detailed above. The number (Mₙ) and weight average (M_{w}) molecular weights of the polycarbonate was measured by GPC and is shown in Tables 3 and 4 below.

TABLE 3

| | | | % | | % | |
|---|---|---|---|---|---|---|
| Time | Impurities | | decrease | | decrease | SVR |
| (min) | (%) | Mₙ | in Mₙ | M_{w} | in M_{w} | (ohm-cm) |
| 0 | Pure PC | 17,136 | — | 41,609 | — | — |
| 1 | 10 | 15,943 | 7.0 | 39,126 | 6.0 | — |
| 3 | 10 | 14,631 | 14.6 | 35,854 | 13.8 | 494,381 |
| 5 | 10 | 14,413 | 15.9 | 35,587 | 14.5 | 44,706 |
| 7 | 10 | 14,070 | 17.9 | 34,396 | 17.3 | 49,851 |
| 10 | 10 | 13,808 | 19.4 | 33,964 | 18.4 | 90,763 |

TABLE 4

| | | | % | | % | |
|---|---|---|---|---|---|---|
| Time | Impurities | | decrease | | decrease | SVR |
| (min) | (%) | Mₙ | in Mₙ | M_{w} | in M_{w} | (ohm-cm) |
| 0 | Pure PC | 17,136 | — | 41,609 | — | — |
| 1 | 3 | 14,979 | 12.6 | 36,282 | 12.8 | 7,353 |
| 3 | 3 | 14,802 | 13.6 | 35,822 | 13.9 | 6,550 |
| 5 | 3 | 14,110 | 17.7 | 33,788 | 18.8 | 37,918 |
| 7 | 3 | 13,740 | 19.8 | 32,839 | 21.1 | 70,782 |
| 10 | 3 | 13,509 | 21.2 | 32,128 | 22.8 | 91,215 |

From Tables 3 and 4 above, it may be seen that the compositions containing SWNT-3, generally show appreciable conductivity with very small amount of mixing. From the tables it can also be seen that for comparable amounts of degradation in molecular weight during the blending process, the sample containing the lesser impurities develops a greater electrical conductivity than the sample containing a higher amount of electrical conductivity. Thus, by choosing an appropriate level of impurity for a given composition, it is possible to develop a desirable level of electrical conductivity while minimizing the degradation of physical properties of the organic polymer.

### EXAMPLE 3

These experiments were conducted to determine the effect of carbon nanotubes on the molecular weight of Nylon 6,6 and on the SVR of the resulting blend. In this example, a Nylon 6,6 resin was blended with 3 wt % of the carbon nanotube composition in the DACA mini twin screw extruder for time periods of about 1 minute to about 7 minutes as shown in Tables 5 and 6 below. The extrusion temperature was 275° C., and the screw speed was 150 rpm. The test methods employed were similar to those detailed above. The number (Mₙ) and weight average (M_{w}) molecular weights of the Nylon 6,6 resin was measured by GPC and is shown in Tables 5 and 6 below.

TABLE 5

| | Impurities | | % | | % | |
|---|---|---|---|---|---|---|
| Time | (Residual | | Decrease | | Decrease | SVR |
| (Min) | TGA %) | Mₙ | in Mₙ | M_{w} | in M_{w} | (ohm-cm) |
| 0 | Pure N66 | 24655 | — | 59203 | — | — |
| 1 | 3 | 23441 | 4.9 | 60318 | −1.9 | 182,168 |
| 2 | 3 | 22614 | 8.3 | 59861 | −1.1 | 20,909 |
| 3 | 3 | 22199 | 10.0 | 59809 | −1.0 | 92,515 |
| 5 | 3 | 23819 | 3.4 | 62673 | −5.9 | 168,969 |

TABLE 6

| | Impurities | | % | | % | |
|---|---|---|---|---|---|---|
| Time | (Residual | | Decrease | | Decrease | SVR |
| (Min) | TGA %) | Mₙ | in Mₙ | M_{w} | in M_{w} | (ohm-cm) |
| 0 | Pure N66 | 24655 | — | 59203 | 0.0 | — |
| 1 | 10 | 20253 | 17.9 | 57329 | 3.2 | OL |
| 2 | 10 | 24227 | 1.7 | 63175 | −6.7 | OL |
| 3 | 10 | 24358 | 1.2 | 64521 | −9.0 | 115,327 |
| 5 | 10 | 21935 | 11.0 | 60963 | −3.0 | 876 |
| 7 | 10 | 21221 | 13.9 | 62745 | −6.0 | 382 |

From Tables 5 and 6 above, it may be seen that the compositions having SWNT-3, generally show electrical conductivity with very small amounts of mixing In addition the compositions containing SWNT-3 generally show electrical conductivity that generally remains somewhat consistent with time of mixing. However, those compositions having SWNT-10 show no electrical conductivity up to 3 minutes of mixing time. Once electrical conductivity is developed in the composition containing SWNT-10, it may be seen that this electrical conductivity or surface volume resistivity is highly dependent upon the mixing time. This is advantageous because it permits a tuning of the electrical conductivity of articles derived from the composition. Since the composition containing the SWNT-10 may take a certain amount of mixing prior to developing a percolating electrical network through the resin, it is envisioned that carbon nanotube compositions containing different weight percents of impurities may be blended prior to mixing with the organic polymer. This would permit tuning in a desired level of electrical conductivity and surface volume resistivity for the composition.

The molecular weight of the Nylon 6,6 further shows limited degradation over time. From the Tables 5 and 6 it may be seen that there is a slight reduction in the number average molecular weight (Mₙ) when the composition containing SWNT-3 and SWNT-10 are extruded. It may further be seen that the reduction in molecular weight is greater for the composition containing SWNT-10 than the sample containing SWNT-3. Gas chromatography coupled with mass spectrometry (GC-MS) was performed on the extruded compositions. The results from the GC-MS are shown in Tables 7 and 8 respectively.

TABLE 7
3% SWNT (SWNT-3)/Nylon 6,6

| | | Nylon | | | | | | | | | |
|---|---|---|---|---|---|---|---|---|---|---|---|
| | | 6,6 | | | | | | | | | |
| | | (pure) | | 1 min | | 3 min | | 5 min | | | |
| Ret. | 300° C., 5 Min | Peak | | Peak | | Peak | | Peak | | 7 min | |
| Time | Compound | Area | ppm | Area | ppm | Area | ppm | Area | ppm | Peak Area | ppm |
| 8.20 | d8-toluene | 72172 | 18.86 | 140046 | 18.86 | 86683 | 18.86 | 104894 | 18.86 | 1182824 | 25.84 |
| | Internal Std. | | | | | | | | | | |
| 8.81 | Cyclopentanone | 13274 | 0.35 | 26104 | 0.35 | 25269 | 0.55 | 15570 | 0.28 | 80404 | 1.76 |
| 11.80 | Phenol | 0 | 0.00 | 0 | 0.00 | 0 | 0.00 | 0 | 0.00 | 0.00 | 0.00 |
| 15.00 | Naphthalene | 0 | 0.00 | 0 | 0.00 | 0 | 0.00 | 0 | 0.00 | 15576 | 0.34 |
| 15.20 | Phenol, 4-(1- | 0 | 0.00 | 0 | 0.00 | 0 | 0.00 | 0 | 0.00 | 37206 | 0.81 |
| | methylethyl) | | | | | | | | | | |
| 25.59 | PA-6,6 | 0 | 0.00 | 91055 | 1.23 | 83546 | 1.82 | 82733 | 1.49 | 256009 | 5.59 |
| | Cyclic | | | | | | | | | | |
| | Monomer | | | | | | | | | | |
| | Total | | 0.35 | | 1.58 | | 2.37 | | 1.77 | | 8.50 |

TABLE 8
3% SWNT (SWNT-10)/Nylon 6,6

| | | Pure | | | | | | | | | |
|---|---|---|---|---|---|---|---|---|---|---|---|
| | Materials | Nylon | | | | | | | | | |
| | heated to | 6,6 | | 1 min | | 3 min | | 5 min | | 7 min | |
| Ret. | 300° C., 5 Min | Peak | | Peak | | Peak | | Peak | | Peak | |
| Time | Compound | Area | ppm | Area | ppm | Area | ppm | Area | ppm | Area | ppm |
| 8.20 | d8-toluene | 72172 | 18.86 | 91653 | 18.86 | 100330 | 18.86 | 75020 | 18.86 | 971122 | 25.84 |
| | Internal Std. | | | | | | | | | | |
| 4.780 | Hexane | — | — | — | — | — | — | — | — | 3274216 | 87.122 |
| 8.81 | Cyclopentanone | 13274 | 0.35 | 53404 | 1.10 | 0 | 0.00 | 22875 | 0.58 | 315158 | 8.39 |
| 11.80 | Phenol | 0 | 0.00 | 0 | 0.00 | 0 | 0.00 | 461532 | 11.60 | 43973 | 1.17 |
| 15.00 | Naphthalene | 0 | 0.00 | 50236 | 1.03 | 0 | 0.00 | 59152 | 1.49 | 184589 | 4.91 |
| 15.20 | Phenol, 4-(1- | 0 | 0.00 | 0 | 0.00 | 0 | 0.00 | 361152 | 9.08 | 96634 | 2.57 |
| | methylethyl) | | | | | | | | | | |
| 25.59 | Nylon-6,6 | 0 | 0.00 | 21306 | 0.44 | 71113 | 1.34 | 20784 | 0.52 | 594045 | 15.81 |
| | Cyclic | | | | | | | | | | |
| | Monomer | | | | | | | | | | |
| | Total | | 0.35 | | 2.57 | | 1.34 | | 23.27 | | 119.97 |

From Tables 7 and 8 it may be seen that the compounds that were examined by GC-MS as a result of the Nylon 6,6 degradation were hexane, cyclopentanone, phenol, naphthalene, phenol, 4-(1-mehtylethyl) and Nylon 6,6 cyclic monomer. From the tables it may be seen that the weight percent of the cyclic dimer increases with mixing time for both compositions. The presence of cyclic dimer in the compositions indicates that there is degradation brought on by the presence of the carbon nanotubes during extrusion and the existence of a larger amount of cyclic dimer in those compositions having SWNT-10 indicates that the presence of impurities may contribute to the degradation in number average molecular weight.

### EXAMPLE 4

This example was undertaken to determine the differences in performance between masterbatches made from MWNTs (that do not display roping) and SWNTs (that show roping) when such masterbatches are made under high shear conditions, such as for example on a 30 mm Werner and Pfleiderer twin-screw extruder. In this example, masterbatches comprising 3 wt % of either MWNTs or SWNTs was first extruded on the 30 mm Werner and Pfleiderer twin-screw extruder.

The conditions utilized on the 30 mm Werner and Pfleiderer twin screw extruder for the preparation of the masterbatches were a barrel temperature of 280° C., a screw speed of 350 rpm with an output of 30 lbs/hr. The polyamide used in the polyphenylene ether-polyamide blend was nylon 6,6. The polyphenylene ether polyamide blend was first compounded on a 30 mm Werner and Pfleiderer twin screw extruder at 290° C. The screw speed was maintained at 350 rpm and the blend was produced at 50 lbs/hr.

The specific volume resistivity for the respective masterbatches is shown in Table 9 below.

TABLE 9

| Masterbatch | Masterbatch having | Masterbatch having | SVR |
|---|---|---|---|
| containing MWNTs | SWNT-10 | SWNT-3 | kΩ-cm |
| 3.0 | — | — | 19.1 |
| — | 3.0 | — | — |
| — | — | 3.0 | 0.025 |

From the table, it may be seen that the masterbatch containing the SWNT-3 displays electrical properties, while the masterbatch having SWNT-10 does not display any volume resistivity. Also, at equivalent loadings, the sample containing SWNT-3 outperforms the MWNT by nearly 3 orders of magnitude. This shows that carbon nanotubes that rope can improve electrical conductivity more rapidly than carbon nanotubes that do not rope.

The 3 wt % masterbatch was then reduced by mixing with additional nylon 6,6 in a 30 mm Werner and Pfleiderer twin screw extruder to form an intermediate conductive composition as shown in Table 10. The compositions then blended with additional ingredients to get the composition in Table 11. The polyphenylene ether-polyamide blends shown in Table 11 was extruded in a separate run on the 30 mm twin screw extruder. The final content of the Nylon 6,6 and the nanotubes are shown in Table 10. The electrical conductivity (SVR) results are shown in Table 12.

The extruder conditions used for the preparation of the polyphenylene ether-polyamide blend as well as the polyphenylene ether-polyamide blend containing the nanotubes were a barrel temperature of 290° C., a screw speed of 350 rpm with an output of 50 lbs/hr. The electrical properties of the polyphenylene ether-polyamide blend containing the nanotubes are shown in Table 12. From Table 12 it can be seen that while the samples containing the MWNT do not display any electrical conductivity, the samples having the SWNTs do show electrical conductivity.

TABLE 10

| Sample # | Nylon 6,6 | MWNT | SWNT-10 | SWNT-3 |
|---|---|---|---|---|
| 1 | 39.87 | 0.60 | — | |
| 2 | 39.87 | 0.90 | — | |
| 3 | 39.87 | 1.20 | — | |
| 4 | 39.87 | — | 0.60 | |
| 5 | 39.87 | — | 0.90 | |
| 6 | 39.87 | — | 1.20 | |
| 7 | 39.87 | | | 0.60 |
| 8 | 39.87 | | | 0.90 |
| 9 | 39.87 | | | 1.20 |

TABLE 11

| | Polyphenylene | Citric | Cupric | Irganox | Potassium | Kraton G | Kraton G | Nylon 6,6 |
|---|---|---|---|---|---|---|---|---|
| Sample # | ether | Acid | Iodide | 1076 | Iodide | 1651 | 1701X | (downstream) |
| 1 | 38.54 | 0.65 | 0.01 | 0.30 | 0.10 | 7.00 | 3.5 | 10.00 |
| 2 | 38.54 | 0.65 | 0.01 | 0.30 | 0.10 | 7.00 | 3.5 | 10.00 |
| 3 | 38.54 | 0.65 | 0.01 | 0.30 | 0.10 | 7.00 | 3.5 | 10.00 |
| 4 | 38.54 | 0.65 | 0.01 | 0.30 | 0.10 | 7.00 | 3.5 | 10.00 |
| 5 | 38.54 | 0.65 | 0.01 | 0.30 | 0.10 | 7.00 | 3.5 | 10.00 |
| 6 | 38.54 | 0.65 | 0.01 | 0.30 | 0.10 | 7.00 | 3.5 | 10.00 |
| 7 | 38.54 | 0.65 | 0.01 | 0.30 | 0.10 | 7.00 | 3.5 | 10.00 |
| 8 | 38.54 | 0.65 | 0.01 | 0.30 | 0.10 | 7.00 | 3.5 | 10.00 |
| 9 | 38.54 | 0.65 | 0.01 | 0.30 | 0.10 | 7.00 | 3.5 | 10.00 |

TABLE 12

| | | | Specific | | |
|---|---|---|---|---|---|
| | | | Volume | | |
| | | | resistivity | | MV |
| MWNT Fibril | | | (SVR) | Izod | (Pa-s) |
| Hyperion | SWNT-10 | SWNT-3 | kΩ-cm | (kj/m2) | 282C |
| 0.6 | — | — | — | 23.8 | 218 |
| 0.9 | — | — | — | 27.5 | 214 |
| 1.2 | — | — | — | 26.5 | 214 |
| — | 0.6 | — | 441 | 23.8 | 232 |
| — | 0.9 | — | 156 | 17 | 235 |
| — | 1.2 | — | 38 | 14.8 | 233 |
| — | — | 0.6 | — | — | — |
| — | — | 0.9 | — | — | — |
| — | — | 1.2 | — | — | — |

These results clearly show that the masterbatches containing the SWNT-10 behave differently from those containing the MWNTs or those containing SWNT-3. From the results it may be seen that while the masterbatch containing the SWNT-10 are not conductive, the masterbatch containing the MWNTs are conductive. The masterbatch containing the SWNT-3 is also conductive as evidenced by the measured bulk volume resistivity. However, upon further compounding the masterbatch with the polyphenylene ether-polyamide blends, the compositions having the MWNTs are non-conductive, while the composition containing the SWNT-10 show a fairly low level of bulk volume resistivity. The compositions having the SWNT-3 are generally electrically non conductive.

Without being limited to theory, it is surmised that presence of the SWNT-10 promotes the disentangling and subsequent dispersion of the single wall nanotubes thereby improving electrical conductivity. The SWNT-10 needed additional shear force or mixing in order to set up the connected network of ropes. The SWNT-3 on the other hand were already set up in a very nicely connected roped network in the masterbatch, but additional mixing collapsed the network thus destroying the connectivity and thus eliminating the conductivity. Hence the polyphenylene-ether polyamide blends having the SWNTs with the lower fraction of impurities generally do not display electrical properties when dispersed in the aforementioned manner. Once again without being limited by theory, it is believed that with respect to the MWNTs, the additional shear provided during the blending of the masterbatch with polyphenylene ether polyamide blend promotes a reduction in the connectivity of the network, which degrades the electrical properties of the samples.

### EXAMPLE 5

The example was undertaken to demonstrate the differences in electrical properties between compositions comprising MWNTs and those comprising SWNT-10. In particular, this experiment was undertaken to study the effect of a semi-crystalline polymer on the electrical and impact properties of compositions containing either MWNTs or SWNTs. A pre-extruded composition comprising polyphenylene ether resin having an intrinsic viscosity of about 0.46 dl/g, styrene butadiene styrene triblock copolymer, high impact polystyrene (HIPS) and Tuftec impact modifier for polypropylene, was manufactured in a Werner and Pfleiderer 30 mm twin screw extruder. A separate masterbatch comprising polypropylene (PD403) and either MWNTs or SWNTs was prepared in a 16 mm Prism twin screw extruder. The pre-extruded composition along with the masterbatch was then extruded in a 16 mm Prism twin screw extruder. Both the pre-extruded composition and the masterbatch were then fed into the extruder at the throat. The samples were injection molded on a 15 ton Boy injection molding machine into Izod bars. The bars were notched and subjected to Notched Izod impact testing as well as to measurements for the determination of specific volume resistivity.

TABLE 13

| Pre-extruded in 30 mm Werner and | | | | Pre-extruded in 16 mm | | | | |
|---|---|---|---|---|---|---|---|---|
| Pfleiderer Twin Screw Extruder | | | | Prism Twin Screw Extruder | | | ASTM Izod Bar | |
| Extruded in Prism 16 mm Twin Screw Extruder. | | | | | | | Mean Values | |
| PPO | | | | PP | | SWNT- | SVR | Izod |
| 0.46IV | SBS | HIPS | TUFTEC | PD403 | MWNT | 10 | (KΩ-cm) | (ft-lbs/inch) |
| 17 | 5 | 10 | 8 | 59 | 1 | | — | 1.76 |
| 17 | 5 | 10 | 8 | 58 | 2 | | — | 1.32 |
| 17 | 5 | 10 | 8 | 57 | 3 | | 450 | 1.29 |
| 17 | 5 | 10 | 8 | 59 | | 1 | 650 | 1.70 |
| 17 | 5 | 10 | 8 | 58 | | 2 | 198 | 1.49 |
| 17 | 5 | 10 | 8 | 58 | | 0 | — | 2.11 |

From the data in Table 13 it may be seen that may be seen that compositions containing the MWNTs did not demonstrate the existence of any measurable electrical conductivity. However, the samples containing the SWNTs show electrical resistivity at 1 and 2 wt %. These results clearly demonstrate that under certain conditions SWNTs having impurities are preferable to MWNTs for producing electrical properties in semi-crystalline resins. This reflects the ability of the roped carbon nanotubes to form a network.

### EXAMPLE 6

This experiment was undertaken to demonstrate the effect of impurities present in a SWNT composition on the electrical properties of a composition comprising a polycarbonate resin and the SWNT composition. The SWNTs were obtained from Carbon Nanotechnologies Incorporated and contained 10 wt % impurities based on residual TGA burnoff (SWNT-10) or 3 wt % impurities based on residual TGA burnoff (SWNT-3). These samples were obtained from a sonication process in which the SWNTs were sonicated in dichloroethane for 30 minutes, the polymer was added, and then the mixture was sonicated again for 30 minutes. The sample was dried, crushed, and then a strand was formed using a small scale laboratory mixing and molding machine (Atlas USA), the strands were fractured using liquid nitrogen, and then the fractured ends were painted with conductive silver paint, and the electrical resistance was measured using a Fluke multimeter.

The SWNT compositions are shown in Table 14 below. The remainder of the composition is PC175 polycarbonate resin commercially available from the General Electric Corporation.

TABLE 14

| | Specific Volume Resistivity |
|---|---|
| Formulation | (kohm-cm) |
| 0.3 wt % SWNT-10 | 390 |
| 0.3 wt % SWNT-3 | — |
| 0.3 wt % SWNT (25% SWNT-3 and 75% | 27 |
| SWNT-10) | |
| 0.3 wt % SWNT (25% SWNT-3 and 75% | 8 |
| SWNT-10) (repeat) | |
| 0.2 wt % SWNT (25% SWNT-3 and 75% | 400 |
| SWNT-10) | |

From the Table 14 it may be seen that the composition containing the SWNT composition having a higher percentage of impurities generally produces better electrical properties. Thus the composition having SWNT-10 shows electrical resistivity, while the composition having SWNT-3 does not show any electrical resistivity. When SWNT-3 is combined with SWNT-10, connectivity in the network is changed by combining carbon nanotubes that have a higher level of impurities than those that have a low level of impurities. The SWNT-3 tends to aggregate with mixing, while the SWNT-10 tends to form more of a network structure. The resulting percolating network is therefore a combination of a carbon nanotube composition that has more aggregates than thin ropes, with a carbon nanotube composition that has more thin ropes than aggregates. The thin ropes thus can help connect the aggregates. The overall result is a lower volume resistivity because a different network has been setup. This facilitates a more efficient packing of the nanotubes into network structures that can percolate through the mass of the organic polymer.

From the above experiments, it may be seen that impurities present in the SWNT compositions offer a wide variety of opportunities for varying mixing time, tuning the electrical properties of the composition, and modifying the physical properties of the composition. In one embodiment, it may be seen that the composition may be subjected to varying levels of mixing to set up different electrical networks in the system, which produce varying levels of electrical resistivity in the matrix of the organic polymer. In another embodiment, in organic polymers such as polycarbonate, the SWNT composition having the higher level of impurities can be dispersed with a lower level of shear mixing. In yet another embodiment, in organic polymers such as nylon 6,6, it may be seen that while the composition containing the lower weight fraction of impurities generally does not change electrical conductivity with mixing, the composition containing the higher weight fraction of impurities develops a higher level of electrical conductivity with mixing time.

Without being limited by theory, it is generally believed that the level of impurities plays a large role in the effectiveness of dispersing the SWNT. Highly pure SWNT cannot be separated from the ropes as easily as the less pure SWNT. It appears that shear forces, such as those used in twin screw extrusion can help to de-rope, or de-agglomerate the SWNTs from the highly entangled clusters, within a short time period. Shear forces developed during the extrusion process are not as effective at breaking up the aggregates of SWNT formed by highly pure SWNTs. However, with the SWNT-3, diffusional effects during mixing in the extruder can greatly improve the conductive SWNT network. In other words, the polymer chains can diffuse in between the SWNT and help disrupt the ropes. The carbon nanotubes with higher impurities (e.g. the grade SWNT-10) are harder to break down from their aggregates or large ropes, but requires additional shear they can be dispersed. The carbon nanotubes with lower impurities set up a network much faster, but the network tends to collapse with additional shear/mixing. This permits one desirous of obtaining a conductive composition from tuning in a desired level of conductivity by varying the amount of impurities in the carbon nanotube composition.

When highly pure SWNTs, are to be used in the composition, the SWNTs are dry blended with the organic polymer and then fed into an extruder. Initially the very large ropes (>10,000 SWNT) are easily broken down into smaller ropes by the extruder. This can set up a conductive pathway, but usually not at very low loadings. Additional compounding can begin to separate even more of the ropes into smaller ones. However, there does eventually come a point at which the separated rope structures become entangled and clumped, or agglomerated. This is shown in FIG. 3. This action destroys the connectivity of the network, and therefore lowers the effectiveness of such highly pure SWNT as conductive elements in the composition.

When carbon nanotubes that have greater than 3wt % impurities, based on residual TGA burnoff are used, the very large rope structures (>10,000 SWNT) are broken down into smaller ropes by the extruder. Additional compounding does further this break up of the agglomerates into a more fishnet type structure which can more easily percolate through the matrix of the organic polymer. This is very favorable in an extrusion operation because it is very easy to impart more shear force into such a mixture of SWNT and an organic polymer. These structures do not form the highly entangled clusters like the highly purified structures do, but rather form nice roped networks that are well connected. The end result is a conductive composite. The impurities present in such nanotubes may be a reason for this.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. An electrically conductive composition comprising:
an organic polymer; and
a carbon nanotube composition, wherein the carbon nanotube composition comprises carbon nanotubes that can rope and have greater than or equal to about 0.1 wt % production related impurities, based on the total weight of the carbon nanotube composition, and wherein the composition has a bulk volume resistivity less than or equal to about 10¹² ohm-cm, and a notched Izod impact strength of greater than or equal to about 5 kilojoules/square meter.

2. The electrically conductive composition of claim 1 wherein the composition has an electrical volume resistivity less than or equal to about 10⁸ ohm-cm, and a notched Izod impact strength greater than or equal to about 10 kilojoules/square meter.

3. The electrically conductive composition of claim 1 wherein the carbon nanotube composition comprises about 0.001 to about 50 wt %, based on the total weight of the composition.

4. The electrically conductive composition of claim 1, wherein the carbon nanotube composition comprises single wall carbon nanotubes, multiwall carbon nanotubes or a combination comprising at least one of the foregoing carbon nanotubes.

5. The electrically conductive composition of claim 1, wherein the production related impurities comprise carbonaceous reaction by-products, catalytic residues, or a combination comprising at least one of the foregoing.

6. The electrically conductive composition of claim 5, wherein the catalytic residues comprise metals, metal oxides, metal carbides, metal nitrides, or a combination comprising at least one of the foregoing residues.

7. The electrically conductive composition of claim 5, wherein the carbonaceous reaction by-products are defective single wall carbon nanotubes, multiwall carbon nanotubes, branched and/or coiled multiwall carbon nanotubes, amorphous carbon, soot, coke, or a combination comprising at least one of the foregoing reaction by-products.

8. The electrically conductive composition of claim 1, further comprising single wall carbon nanotubes that do not rope, multiwall carbon nanotubes that do not rope, vapor grown carbon fibers, graphitic nanosheets or a combination comprising at least one of the foregoing.

9. The electrically conductive composition of claim 1, wherein the production related impurities comprise about 0.1 to about 80 wt % of the total weight of the carbon nanotube composition.

10. The electrically conductive composition of claim 1, wherein the carbon nanotube composition comprises metallic carbon nanotubes, semi-conducting carbon nanotubes, or a combination comprising at least one of the foregoing single wall carbon nanotubes.

11. The electrically conductive composition of claim 1, wherein the carbon nanotube composition comprises about 1 to about 99 wt % metallic carbon nanotubes based on the total weight of the carbon nanotube composition.

12. The electrically conductive composition of claim 1, wherein the carbon nanotube composition comprises about 1 to about 99 wt % semi-conducting carbon nanotubes based on the total weight of the carbon nanotube composition.

13. The electrically conductive composition of claim 1, wherein the carbon nanotube composition comprises single wall armchair nanotubes, single wall zigzag nanotubes, or a combination comprising at least one of the foregoing types of nanotubes.

14. The electrically conductive composition of claim 1, wherein the organic polymer comprises a homopolymer, a copolymer, a terpolymer, or a combination comprising at least one of the foregoing types of organic polymers.

15. The electrically conductive composition of claim 1, wherein the organic polymer has a phase separated morphology and wherein a substantial proportion of the carbon nanotube composition is present in a single phase.

16. The electrically conductive composition of claim 1, wherein at least a portion of the carbon nanotube composition comprises carbon nanotubes that are derivatized with functional groups.

17. The electrically conductive composition of claim 1, wherein the carbon nanotube composition comprises single wall carbon nanotubes derivatized with a functional group on a side-wall and/or on a hemispherical end of the carbon nanotubes.

18. The electrically conductive composition of claim 1, wherein the carbon nanotube composition comprises single wall carbon nanotubes or multiwall carbon nanotubes having at least one hemispherical end.

19. The electrically conductive composition of claim 1, wherein the organic polymer is a thermoplastic resin, a blend of thermoplastic resin, or blend of a thermoplastic resin with a thermosetting resins.

20. The electrically conductive composition of claim 1, wherein the organic polymer is a copolymer, a terpolymer, a blend of polymers, or combinations comprising at least one of the foregoing organic polymers.

21. The electrically conductive composition of claim 19, wherein the thermoplastic resins are polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polymethylmethacrylates, polyether etherketones, and combinations comprising at least one of the foregoing thermoplastic resins.

22. An electrically conductive composition comprising:
an organic polymer; and
a carbon nanotube composition that comprises carbon nanotubes, wherein the carbon nanotubes of the carbon nanotubes composition have greater than or equal to about 0.1 wt % production related impurities, based on the total weight of the carbon nanotube composition; and wherein the carbon nanotubes are present in the organic polymer in the form of a network that comprises ropes; and wherein the electrically conductive composition has a bulk volume resistivity less than or equal to about 10⁸ ohm-cm, and a notched Izod impact strength of greater than or equal to about 10 kilojoules/square meter.

23. The electrically conductive composition of claim 22, having a Class A surface finish.

24. The electrically conductive composition of claim 22, comprising about 0.001 to about 50 wt % of the carbon nanotube composition, based on the total weight of the electrically conductive composition.

25. The electrically conductive composition of claim 22, wherein the carbon nanotube composition comprises single wall carbon nanotubes, multiwall carbon nanotubes or a combination comprising at least one of the foregoing carbon nanotubes.

26. The electrically conductive composition of claim 22, wherein the production related impurities comprise carbonaceous reaction by-products, catalytic residues, or a combination comprising at least one of the foregoing.

27. The electrically conductive composition of claim 26, wherein the catalytic residues comprise metals, metal oxides, metal carbides, metal nitrides, or a combination comprising at least one of the foregoing residues.

28. The electrically conductive composition of claim 26, wherein the carbonaceous reaction by-products are defective single wall carbon nanotubes, multiwall carbon nanotubes, branched and/or coiled multiwall carbon nanotubes, amorphous carbon, soot, coke, or a combination comprising at least one of the foregoing reaction by-products.

29. The electrically conductive composition of claim 22, wherein the network contains agglomerates of carbon nanotubes, ropes, carbon nanotubes that do not form ropes, or a combination comprising at least one of the foregoing.

30. A electrically conductive composition comprising:
an organic polymer; and
a carbon nanotube composition that comprises carbon nanotubes, wherein the carbon nanotubes of the carbon nanotubes composition have greater than or equal to about 0.1 wt % production related impurities, based on the total weight of the carbon nanotube composition; and wherein the carbon nanotubes are present in the organic polymer in the form of a network that comprises ropes and agglomerates; and wherein the electrically conductive composition has a bulk volume resistivity less than or equal to about 10⁸ ohm-cm, a notched Izod impact strength of greater than or equal to about 10 kilojoules/square meter and a Class A surface finish.

31. The electrically conductive composition of claim 30, comprising about 0.001 to about 50 wt % of the carbon nanotube composition, based on the total weight of the electrically conductive composition.

32. The electrically conductive composition of claim 30, wherein the carbon nanotube composition comprises single wall carbon nanotubes, multiwall carbon nanotubes or a combination comprising at least one of the foregoing carbon nanotubes.

33. The electrically conductive composition of claim 30, wherein the production related impurities comprise carbonaceous reaction by-products, catalytic residues, or a combination comprising at least one of the foregoing.

34. The electrically conductive composition of claim 30, wherein the catalytic residues comprise metals, metal oxides, metal carbides, metal nitrides, or a combination comprising at least one of the foregoing residues.

35. The electrically conductive composition of claim 33, wherein the carbonaceous reaction by-products are defective single wall carbon nanotubes, multiwall carbon nanotubes, branched and/or coiled multiwall carbon nanotubes, amorphous carbon, soot, coke, or a combination comprising at least one of the foregoing reaction by-products.

36. The electrically conductive composition of claim 30, wherein the network contains agglomerates of carbon nanotubes, ropes, carbon nanotubes that do not form ropes, or a combination comprising at least one of the foregoing.

37. A method for manufacturing a composition comprising:
blending an organic polymer and/or an organic polymer precursor composition with a carbon nanotube composition, wherein the carbon nanotube composition comprises carbon nanotubes that can rope, and wherein the carbon nanotube composition comprises an amount of greater than or equal to about 0.1 wt % production related impurities based on the total weight of the carbon nanotube composition.

38. The method of claim 37, wherein the blending comprises melt blending, solution blending or a combination comprising at least one of the foregoing methods of blending.

39. The method of claim 37, wherein the organic polymer precursor composition forms an organic polymer during blending.

40. The method of claim 37, wherein blending comprises sonication conducted at ultrasonic frequencies.

41. The method of claim 37, wherein the organic polymer is semi-crystalline or amorphous and has a molecular weight of about 100 g/mole to about 1,000,000 g/mole.

42. The method of claim 37, wherein the blending uses shear force, extensional force, compressive force, ultrasonic energy, electromagnetic energy, thermal energy or combinations comprising at least one of the foregoing forces and energies and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, screen packs, rolls, rams, helical rotors, or combinations comprising at least one of the foregoing.

43. A method for manufacturing an electrically conductive composition comprising:
blending a carbon nanotube composition with an organic polymer or an organic polymer precursor; wherein the carbon nanotube composition contains carbon nanotubes that can rope; and wherein a rope comprising carbon nanotubes has its dimensions altered upon blending.

44. The method of claim 43, wherein the rope comprises 2 to 10⁵ carbon nanotubes.

45. The method of claim 43, wherein the blending comprises melt blending, solution blending or a combination comprising at least one of the foregoing methods of blending.

46. The method of claim 43, wherein the organic polymer precursor composition forms an organic polymer during blending.

47. The method of claim 43, wherein blending comprises sonication conducted at ultrasonic frequencies.

48. The method of claim 43, wherein the organic polymer is a thermoplastic polymer, a thermosetting polymer, or a blend of a thermoplastic polymer with a thermosetting polymer.

49. The method of claim 43, wherein the organic polymer is a copolymer.

50. The method of claim 43, wherein the organic polymer is a polyacetal, a polyacrylic, a polycarbonate, a polystyrene, a polyester, a polyamide, a polyamideimide, a polyarylate, a polyurethane, a polyarylsulfone, a polyethersulfone, a polyarylene sulfide, a polyvinyl chloride, a polyetherimide, a polytetrafluoroethylene, a polyetherketone, a polymethylmethacrylate, a polyether etherketone, and combinations comprising at least one of the foregoing

51. A method of preparing an electrically conductive composition comprising:
blending a first organic polymer and a carbon nanotube composition to form a masterbatch; wherein the carbon nanotube composition comprises production related impurities in an amount of greater than or equal to about 0.1 wt %, based upon the total weight of the carbon nanotube composition; and wherein the carbon nanotube composition comprises carbon nanotubes that can rope; and
further blending the masterbatch with a second organic polymer to form the electrically conductive composition.

52. The method of claim 51, wherein the masterbatch has a higher electrical volume resistivity than the electrical volume resistivity of the electrically conductive composition.

53. The method of claim 51, wherein the masterbatch has a lower electrical volume resistivity than the electrical volume resistivity of the electrically conductive composition.

54. The method of claim 51, wherein a carbon nanotube rope present in the carbon nanotube composition, has its dimensions altered during the blending to form the masterbatch.

55. The method of claim 51, wherein a carbon nanotube rope present in the carbon nanotube composition, has its dimensions altered during the blending to form the electrically conductive composition.

56. An article manufactured from the composition of claim 1.

57. An article manufactured from the composition of claim 22.

58. An article manufactured from the composition of claim 30.

59. An article manufactured by the method of claim 37.

60. An article manufactured by the method of claim 43.

61. An article manufactured by the method of claim 51.
